(19) United States
(12) Patent Application Publication
(10) Pub. No.: US 2003/0163719 A1
(43) Pub. Date: Aug. 28, 2003

(54) Removable disk device with identification information

(75) Inventor: Eiichi Ebihara, Kawasaki (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU LIMITED

(21) Appl. No.: 10/314,533

(22) Filed: Dec. 9, 2002

(30) Foreign Application Priority Data
Feb. 26, 2002 (JP) 2002-049249

(51) Int. Cl. G06F 12/14

(52) U.S. Cl. 713/193

(57) ABSTRACT

An application of an information processing device obtains a drive ID from a removable disk device and sends the drive ID to a distribution server through a communication network. The distribution server authenticates the disk device, based on the received drive ID, and distributes contents. Then, the application reads the contents from the disk device and reproduces them.

### BACKGROUND OF THE INVENTION

### FIELD OF THE INVENTION

The present invention relates to a removable disk device with a disk storing data and a mechanism reading the data on the disk, and an information processing device connected to such a disk device.

Since if a HDD (hard disk drive) is separated from an information processing device, data can be easily duplicated, the right-holder of copyrighted software contents, such as pictures and music, prohibits the independent installation of a removable HDD. Therefore, such software contents are usually installed in an irremovable HDD built into an information processing device.

Thus, a conventional HDD is designed so as not to manage contents if an HDD and an information processing device are separated. Therefore, it is difficult to use a removable HDD as a medium distributing a large amount of copyrighted digital information, which is a problem.

### SUMMARY OF THE INVENTION

It is an object of the present invention to provide a removable disk device and an information processing device that prevent the illegal use of copyrighted contents.

In the first aspect of the present invention, a removable disk device is connected to an information processing device receiving data from a distribution server, and comprises a disk medium, a reading device, an interface and a writing device.

The disk medium stores unrewritable identification information, and the reading device reads the identification information from the disk medium in response to a request from the information processing device. The interface sends the identification information to the information processing device, and receives data that the information processing device has received from the distribution server using the identification information, from the information processing device. Then, the writing device writes the data onto the disk medium.

In the second aspect of the present invention, a removable disk device is connected to an information processing device reproducing data, and comprises a disk medium, an interface and a writing device.

The disk medium stores unrewritable identification information, and the writing device writes data encrypted in such a way to be decrypted using the identification information, onto the disk medium. Then, the interface sends the identification information and encrypted data to the information processing device.

In the third aspect of the present invention, a removable disk device is connected to an information processing device, and comprises a disk medium, a registration device, an authentication device and an access device.

The registration device registers user identification information and an encryption key of each user in such a way to correspond each other. The authentication device checks whether the information processing device has an encryption key corresponding to user identification information received from the information processing device by exchanging authentication information with the information processing device using the encryption key. If the information processing device has the encryption key, the authentication device authenticates the information processing device. Then, after the authentication, the access device accesses the disk device in response to a request from the information processing device.

In the fourth aspect of the present invention, a removable disk device is connected to an information processing device reproducing data, and comprises a disk medium, an interface, a writing device, a clock and a comparison device.

The writing device writes encrypted data and information representing the expiration time of the data in the disk medium. The clock outputs the current time, and the comparison device compares the current time with the expiration time. Then, the interface transmits information needed to decrypt the encrypted data to the information processing device if the current time is earlier than the expiration time.

In the fifth aspect of the present invention, a removable disk device is connected to an information processing device, and comprises a disk medium, an access device and a setting device.

The setting device sets identification information about the owner of each sector of the disk medium and information representing the access restriction to the sector, of a user other than the owner. Then, the access device accesses a sector under an access restriction when a user other than the owner of the sector attempts to access the sector.

In the sixth aspect of the present invention, a removable disk device is connected to an information processing device reproducing data, and comprises a check device and an access device.

The check device checks whether the removable disk device has unrewritable identification information corresponding to software identification information that the information processing device has, by exchanging authentication information generated using the software identification information with the removable disk device. Then, the access device accesses the data of the removable disk device if the removable disk device has the unrewritable identification information.

In the seventh aspect of the present invention, an information processing device reproducing the data of a removable disk device comprises an authentication device and an access device.

The authentication device checks whether the removable disk device has an encryption key corresponding to identification information of a user, by exchanging authentication information with the removable disk device using the encryption key. If the removable disk device has the encryption key, the authentication device authenticates the removable disk device. Then, after the authentication, the access device accesses the data of the removable disk device in response to a request from the user.

### BRIEF DESCRIPTIONS OF THE DRAWINGS

FIG. 1 shows the principle of the removable disk device of the present invention.

FIG. 2 shows the first removable HDD.

FIG. 3 shows the second removable HDD.

FIG. 4 shows the process of an identification function.

FIG. 5 shows the process of a secret key storage function.

FIG. 6 shows the process of a secret communication function.

FIG. 7 shows the process of a content distribution system.

FIG. 8 shows the process a user management function.

FIG. 9 shows the process of a reciprocal authentication function.

FIG. 10 shows the registration process of a license with expiration time.

FIG. 11 shows the decrypting process of a license with expiration time.

FIG. 12 shows the logical structure of a sector.

FIG. 13 shows the configuration of the removable HDD.

FIG. 14 shows the firmware configuration.

FIG. 15 shows the firmware specifications.

FIG. 16 is a flowchart showing the firmware rewriting procedure.

FIG. 17 shows the first head.

FIG. 18 shows the second head.

FIG. 19 shows the process of a work key generation function.

FIG. 20 shows the configuration of a work key generation circuit.

FIG. 21 shows an encryption checksum process.

FIG. 22 shows the configuration of the encryption checksum circuit.

FIG. 23 shows a user registration process.

FIG. 24 shows a user table.

FIG. 25 is the flowchart of the reciprocal authentication function.

FIG. 26 shows a reciprocal authentication mechanism.

FIG. 27 is the flowchart of a DID sending function.

FIG. 28 shows a DID sending process.

FIG. 29 shows a DID sending mechanism.

FIG. 30 shows the configuration of a clock.

FIG. 31 shows the process of a sector management function.

FIG. 32 shows a sector authentication table.

FIG. 33 shows storage media.

### DESCRIPTION OF THE PREFERRED EMBODIMENTS

The preferred embodiments of the present invention are described below with reference to the drawings.

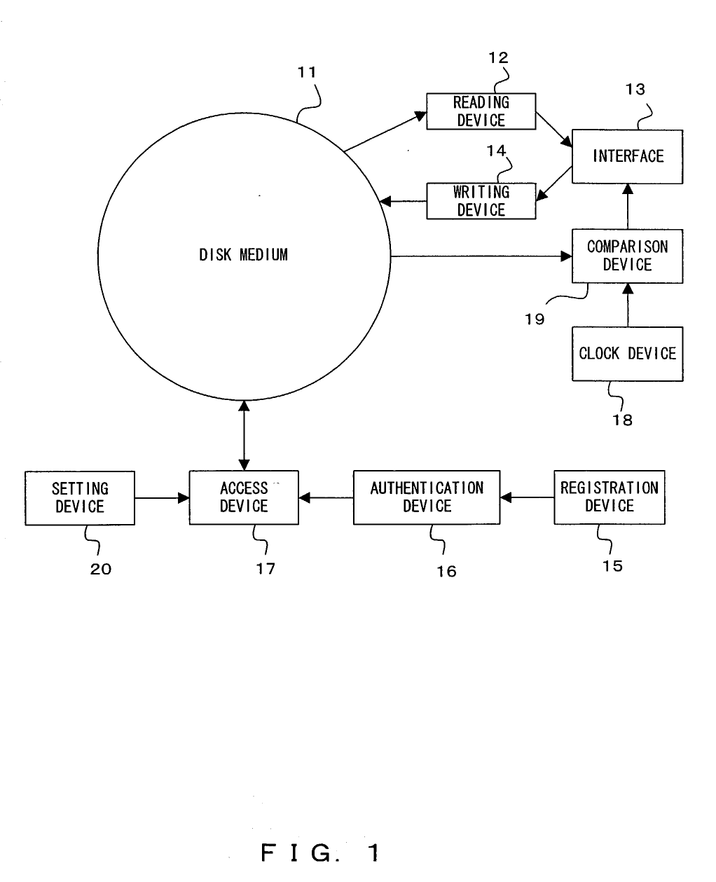

FIG. 1 shows the principle of the removable disk device of the present invention.

In the first aspect of the present invention, the removable disk device is connected to an information processing device receiving data from a distribution server, and comprises a disk medium 11, a reading device 12, an interface 13 and a writing device 14.

The disk medium 11 stores unrewritable identification information, and the reading device 12 reads the identification information from the disk medium 11 in response to a request from the information processing device. The interface 13 sends the identification information to the information processing device, and receives data that the information processing device has received from the distribution server using the identification information, from the information processing device. Then, the writing device 14 writes the data onto the disk medium 11.

Since a user cannot rewrite the identification information recorded on the disk medium 11, in order to receive data from the distribution server, the information processing device must request the distribution server to send data using the identification information. Therefore, data cannot be distributed to another removable disk device without correct identification information and illegal downloading is prevented accordingly.

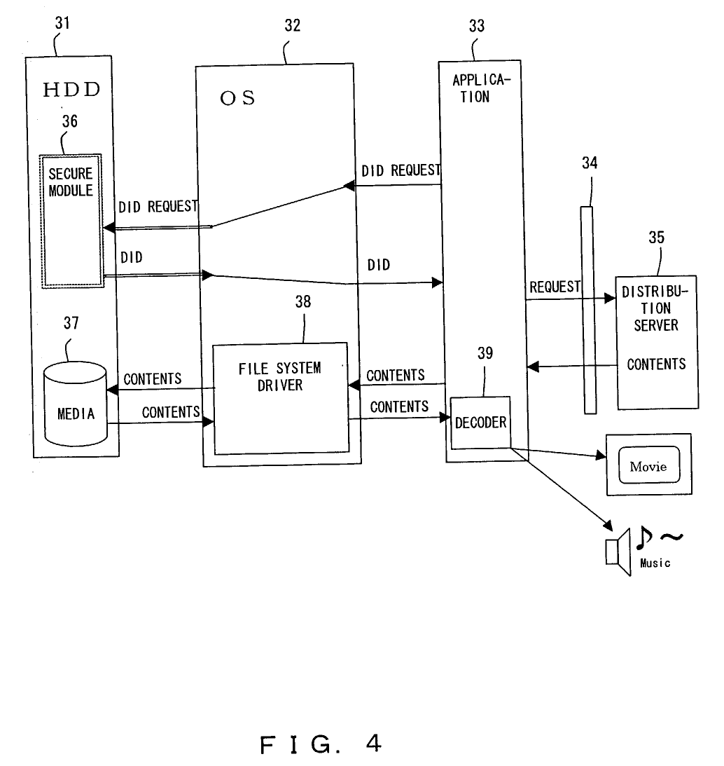

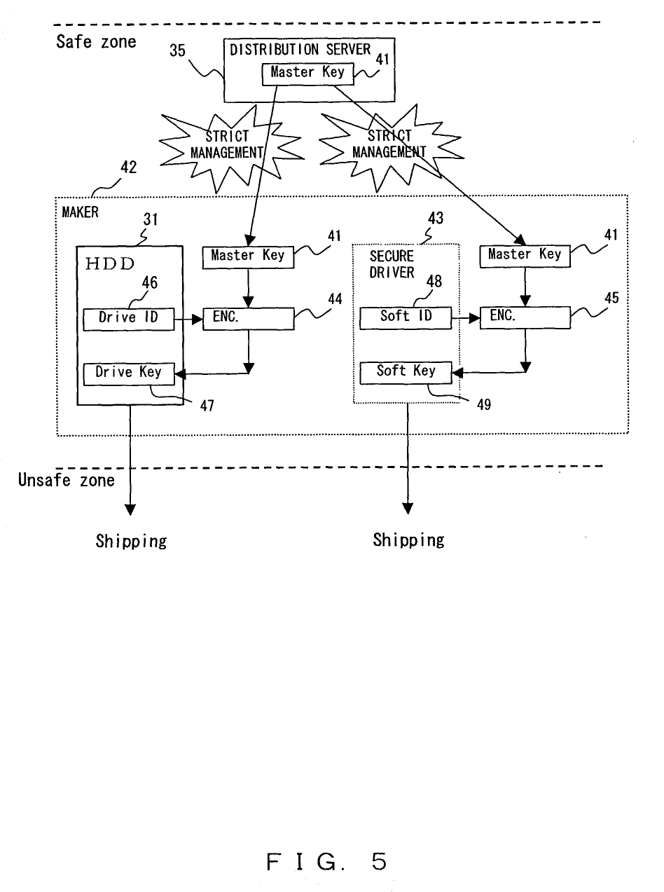

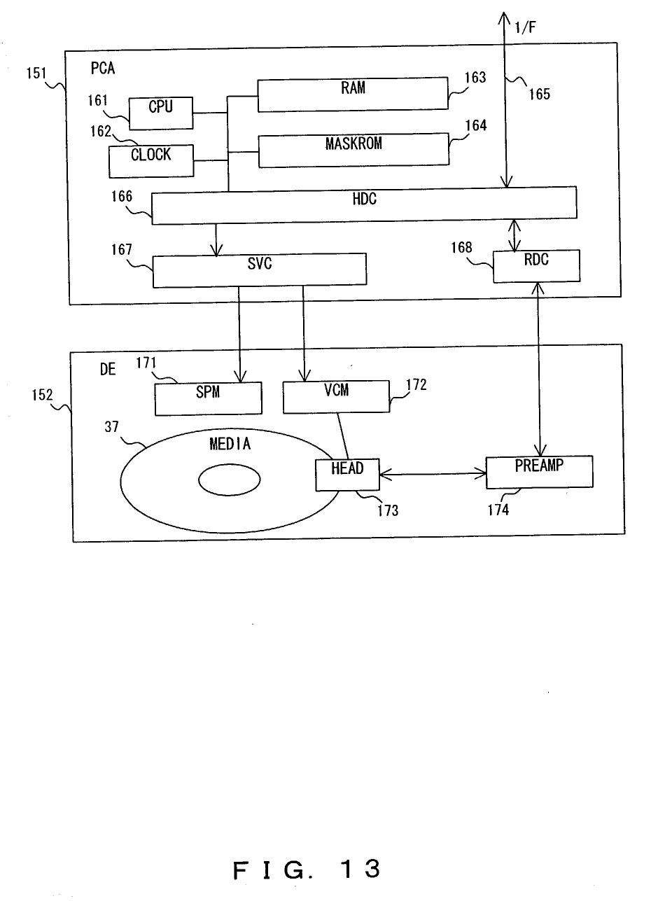

In this case, the disk medium 11 corresponds to, for example, the media 37 shown in FIG. 4, which is described later. The reading device 12 and writing device 14 correspond to, for example, the head 173 shown in FIG. 13, which is described later. The interface 13 corresponds to, for example, the I/F 165 shown in FIG. 13. Unrewritable identification information corresponds to, for example, the drive ID 46 shown in FIG. 5, which is described later.

In the second aspect of the present invention, the removable disk device is connected to an information processing device reproducing data, and comprises a disk medium 11, an interface 13 and a writing device 14.

The disk medium 11 stores unrewritable identification information, and the writing device 14 writes data encrypted in such a way as to be decrypted using the identification information, onto the disk medium 11. Then, the interface 13 sends the identification information and encrypted data to the information processing device.

Since a user cannot rewrite the identification information recorded on the disk medium 11, in order to reproduce encrypted data, the information processing device must decrypt the data using the identification information. Therefore, even if the encrypted data is copied to another removable disk device without correct identification information, the disk device cannot reproduce the data. Thus, illegal use of the data is prevented.

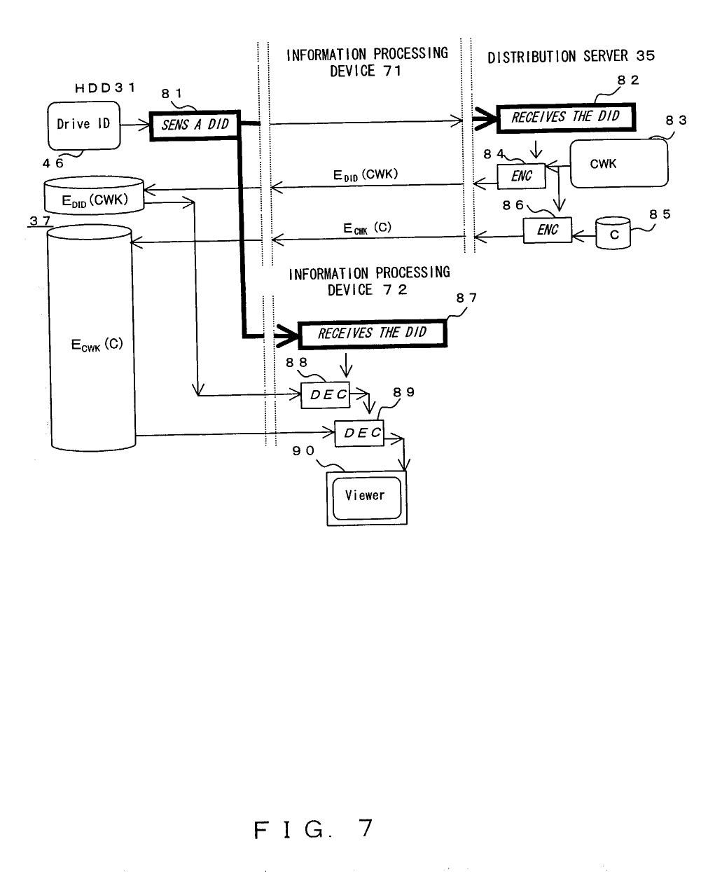

In this case, the encryption method to be decrypted using the identification information corresponds to, for example, the content encryption method shown in FIG. 7, which is described later.

In the third aspect of the present invention, the removable disk device is connected to an information processing device, and comprises a disk medium 11, a registration device 15, an authentication device 16 and an access device 17.

The registration device 15 registers identification information and an encryption key of each user in such a way to correspond each other. The authentication device 16 checks whether the information processing device has an encryption key corresponding to user identification information received from the information processing device, by exchanging authentication information with the information processing device, using the encryption key. If the information processing device has the encryption key, the authentication device authenticates the information processing device. Then, after the authentication, the access device 17 accesses the disk device in response to a request from the information processing device.

The registration device 15 stores a different encryption key for each user. If a specific user attempts to access the disk medium 11, the authentication device 16 receives the user identification information about the user from the information processing device. The authentication device 16 performs authentication of the information processing device using an encryption key corresponding to the user identification information and authenticates an information processing device with the same encryption key as a trusted device. Then, the access device 17 receives an access request from the authenticated information processing device.

According to such a configuration, unless the respective user encryption keys registered in a removable disk device and an information processing device are the same, a user cannot access the removable disk device. Therefore, even if a user attempts to access the removable disk device using another information processing device without such an encryption key, the access is prohibited. Therefore, the combination of a removable disk device and an information processing device can be restricted and the illegal use of the data using another information processing device can be prevented.

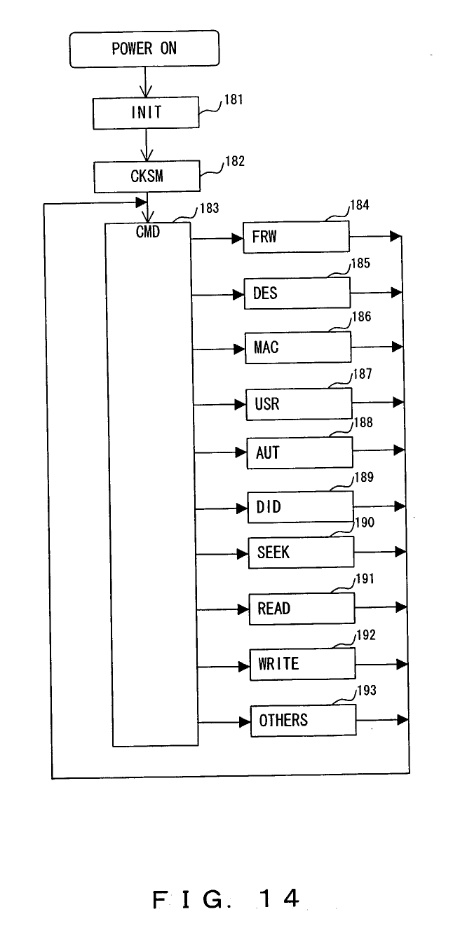

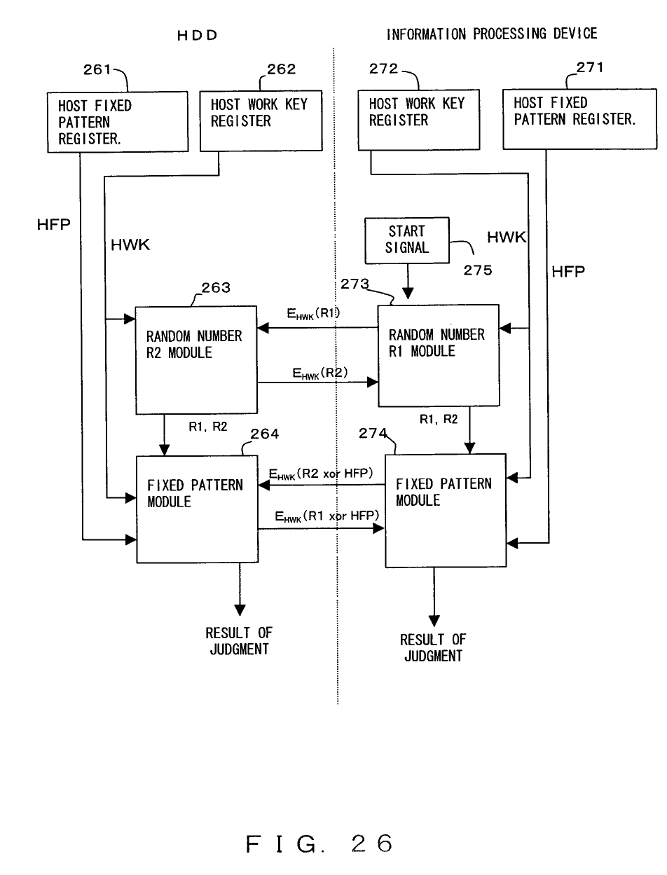

In this case, the registration device 15 corresponds to, for example, the USR 187 shown in FIG. 14, which is described later. The authentication device 16 corresponds to, for example, the AUT 188 shown in FIG. 14 or the modules 263 and 264 shown in FIG. 26, which are described later. The access device 17 corresponds to, for example, the head 173 shown in FIG. 13.

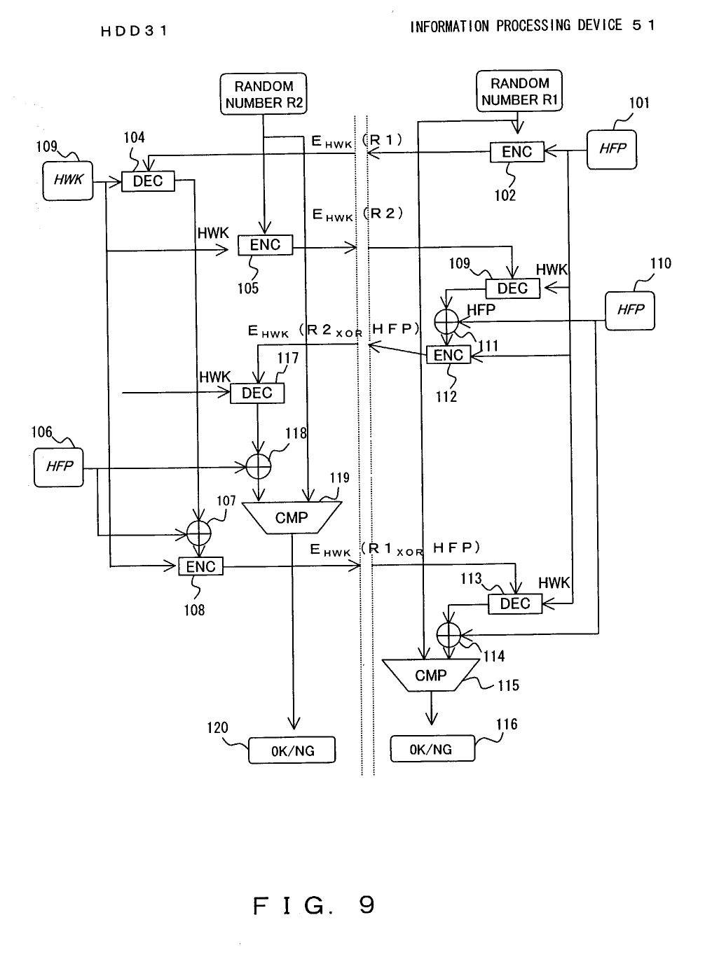

An encryption key corresponding to user identification information corresponds to, for example, the HWK 101 and 103 shown in FIG. 9, which are described later. Exchanged authentication information corresponds to, for example, E_{HWK}(R1), E_{HWK}(R2), E_{HWK}(R1 xor HFP) and E_{HWK}(R2 xor HFP) which are shown in FIG. 9.

In the fourth aspect of the present invention, the removable disk device is connected to an information processing device reproducing data, and comprises a disk medium 11, an interface 13, a writing device 14, a clock 18 and a comparison device 19.

The writing device 14 writes encrypted data and information representing the expiration time (expiration date and time) of the data, onto the disk medium 11. The clock 18 outputs the current time, and the comparison device 19 compares the current time with the expiration time. Then, the interface 13 sends information needed to decrypt the encrypted data to the information processing device if the current time is earlier than the expiration time.

According to such a configuration, the removable disk device can manage the expiration time of data written on the disk medium 11, and if the current time is later than the expiration time, the information processing device cannot reproduce encrypted data. Therefore, the illegal use of the data with expired expiration time can be prevented. For example, if only the software license data is written on the disk medium 11, the removable disk device can manage the expiration time of a license by itself.

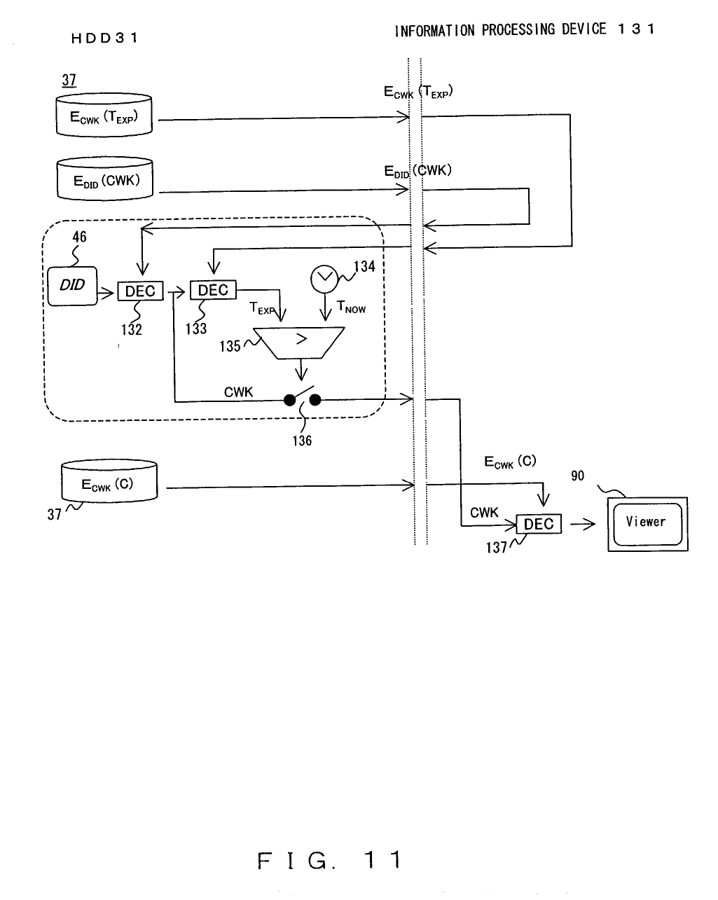

In this case, the clock 18 corresponds to the built-in clock 134 shown in FIG. 11, which is described later. The function of the comparison device 19 corresponds to reference numeral 135 shown in FIG. 11.

In the fifth aspect of the present invention, the removable disk device is connected to an information processing device, and comprises a disk medium 11, an access device 17 and a setting device 20.

The setting device 20 sets identification information about the owner of each sector of the disk medium 11 and information representing the restrictions on access to the sector, of users other than the owner. Then, the access device 17 accesses a sector under the restrictions when a user other than the owner of the sector attempts to access the sector.

According to such a configuration, an owner is set for each sector of the disk medium 11, and the access to a specific sector of users other than the owner of the sector can be restricted. Thus, a plurality of users can use one removable disk device and each user can also share data with another user within proper access restrictions. Thus, illegal access beyond the restrictions can be prevented.

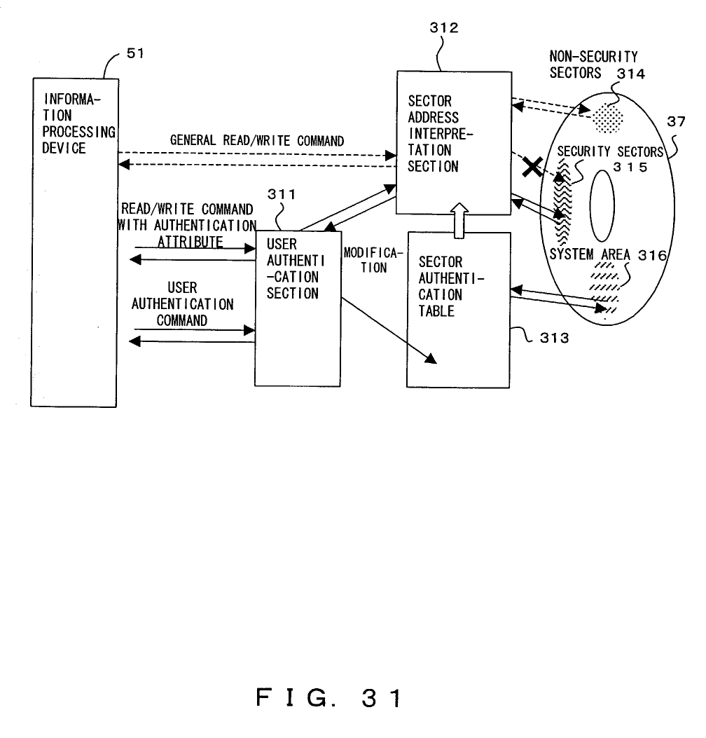

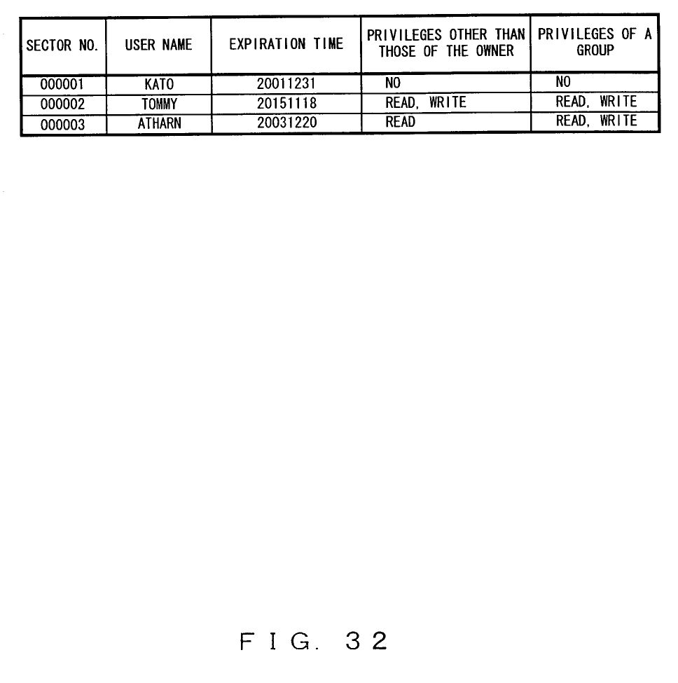

In this case, the setting device 20 corresponds to, for example, the user authentication unit 311 shown in FIG. 31, which is described later. The access restrictions of a user other than the owner corresponds to the privileges of a user other than the owner and privileges of a group shown in FIG. 32, which are described later.

In the sixth aspect of the present invention, the removable disk device is connected to an information processing device reproducing data, and comprises a check device and an access device.

The check device checks whether the removable disk device has unrewritable identification information corresponding to software identification information that the information processing device has, by exchanging authentication information generated using the software identification information, with the removable disk device. Then, the access device accesses the data of the removable disk device if the removable disk device has the unrewritable identification information.

When the information processing device attempts to access the data of the removable disk device, the check device performs authentication of the removable disk device using software identification information and authenticates a removable disk device with unrewritable identification information corresponding to the software identification information as an access target. Then, the access device accesses the data of the authenticated removable disk device.

According to such a configuration, if the software identification information of the information processing device does not correspond to the identification of the removable disk device, the information processing device cannot access the removable disk device. Thus, even if a user attempts to access a removable disk device without such identification information, the access is prohibited. Therefore, the number of removable disk devices that the information processing device can access can be restricted and the illegal use of data of other removable disk devices can be prevented.

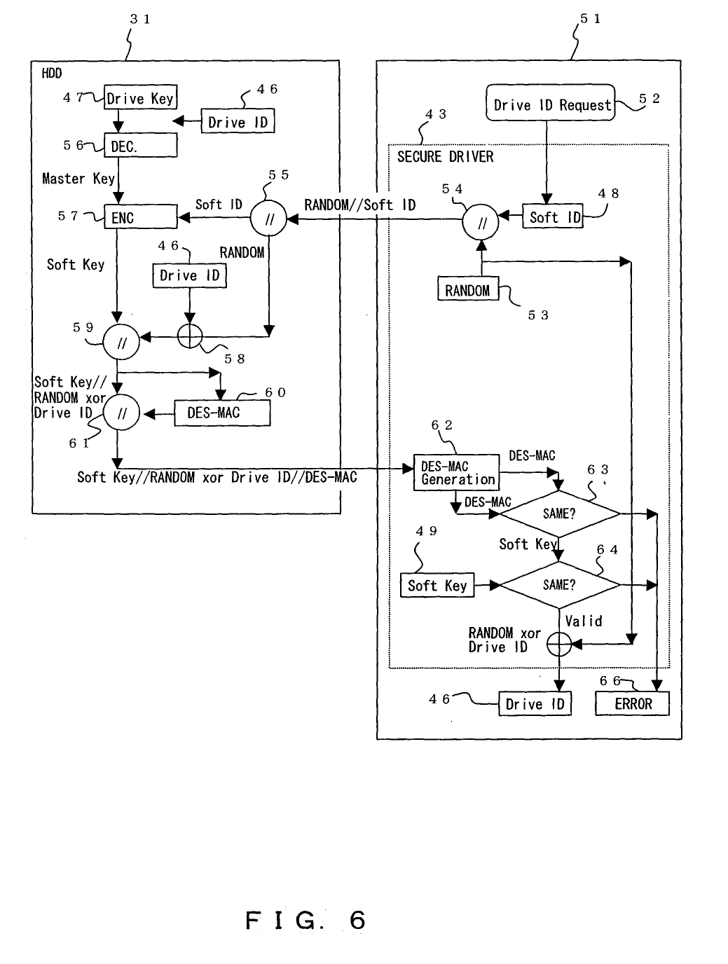

In this case, the check device corresponds to the security driver 43 shown in FIG. 6, which is described later, and the function of the access device corresponds to the reference numerals 88 and 89 shown in FIG. 7, which are described later. The software identification information corresponds to, for example, the soft ID 48 shown in FIG. 6, and the exchanged authentication information corresponds to, for example, “RANDOM//Soft ID” and “Soft key//RANDOM xor Drive ID//DES-MAC”, which are shown in FIG. 6.

In the seventh aspect of the present invention, the information processing device reproducing the data of a removable disk device comprises an authentication device and an access device.

The authentication device checks whether the removable disk device has an encryption key corresponding to the identification information of a user by exchanging authentication information with the removable disk device using the encryption key. If the removable disk device has the encryption key, the authentication device authenticates the removable disk device. Then, after the authentication, the access device accesses the data of the removable disk device in response to a request from the user.

When a specific user inputs identification information to the information processing device and attempts to access the data of the removable disk device, the authentication device performs authentication of the removable disk device using an encryption key corresponding to the identification information and authenticates the removable disk device with the encryption key corresponding to the identification information, as an access target. Then, the access device accesses the requested data of the authenticated removable disk device.

According to such a configuration, if the respective user encryption keys registered in the removable disk device and information processing device are different, a user cannot access the removable disk device. Thus, even if the user attempts to access a removable disk device without such an encryption key, the access is prohibited. Therefore, the illegal use of the data of the removable disk device can be prevented.

In this case, the function of the authentication device corresponds to, for example, the reference numerals 102, 109, 111, 112, 113, 114 and 115 shown in FIG. 9. Furthermore, the authentication device also corresponds to the modules 273 and 274 shown in FIG. 26, which are described later. The function of the access device corresponds to, for example, the reference numerals 87, 88 and 89 shown in FIG. 7.

The encryption key corresponding to user identification information, corresponds to, for example, the HWK 101 and 103 shown in FIG. 9, and the exchanged authentication information corresponds to, for example, the E_{HWK}(R1), E_{HWK}(R2), E_{HWK}(R1 xor HFP) and E_{HWK}(R2 xor HFP) shown in FIG. 9.

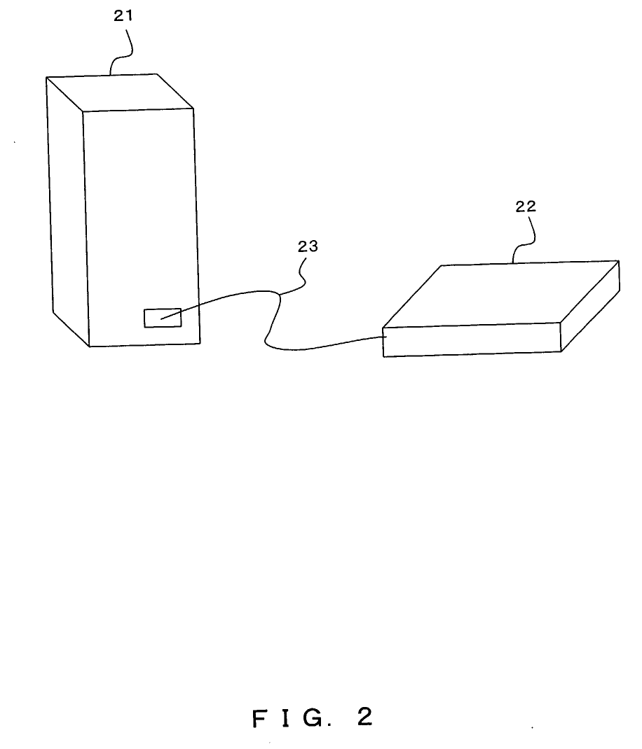

FIG. 2 shows the form of the removable HDD. The removable HDD 22 shown in FIG. 2 is connected to an information processing device (host) 21 through an interface cable 23.

The information processing device 21 corresponds to, for example, a PC (personal computer) or a contents reproduction device (video player) and has a function to output data recorded on the HDD 22. The interface cable 23 corresponds to, for example, a USB (universal serial bus) cable or an IEEE (Institute of Electrical and Electronic Engineers) 1394 cable.

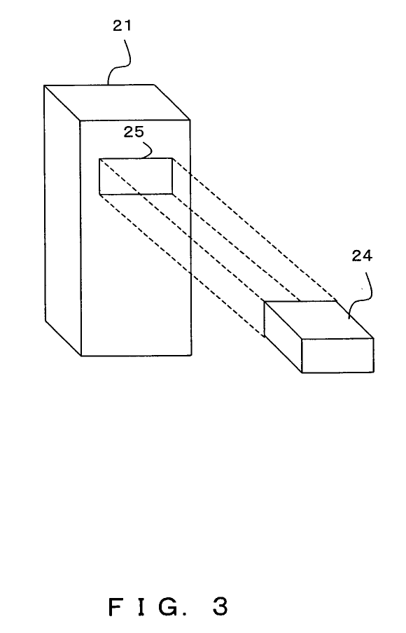

FIG. 3 shows the form of another removable HDD. The removable HDD 24 shown in FIG. 3 is inserted in the slot 25 of the information processing device 21.

Contents stored in the removable HDD include reproduction data, such as pictures and music, and copyright data (license data). In this preferred embodiment, the HDD and information processing devices are provided with an identification function, a secret key storage function, a secret communication function, a user management function, a reciprocal authentication function, a clock function and a sector management function. These functions can be basically realized by software or hardware. Each function is described below in order.

(1) Identification Function

This function provides each HDD with secret identification information (authentication number) corresponding to the serial number of the HDD one to one in order to identify each HDD. This identification information is assumed to be called “drive ID (DID)”. For the DID, a symbol string is used such that it cannot be easily inferred unlike a serial number.

FIG. 4 shows the process of an identification function using this DID. A removable HDD 31 is connected to an information processing device provided with an OS (operating system) 32 and an application 33, and stores contents distributed by a distribution server 35. The application 33 is an application program reproducing the contents and does not store distributed data in a removable HDD without a DID.

First, the application 33 requests the OS 32 to send the DID of the HDD 31. Then, in response to the request, the OS 32 issues a DID request to the HDD 31. The secure module 36 of the HDD 31 with an identification function sends a DID as a plain text. The OS 32 returns the received DID to the application 33. The application 33 sends the received DID to the distribution server 35 through a communication network 34, such as the Internet or the like, and requests the distribution server 35 to distribute contents.

The distribution server 35 authenticates the HDD 31, based on the received DID and distributes contents. The application 33 transfers the distributed contents to the OS 32. Then, the file system driver 38 of the OS 32 stores the contents in the media 37 of the HDD 31. Then, the application 33 reads the contents from the media 37 through the file system driver 38. Then, the application 33 decrypts the contents using a decoder 39 and reproduces the contents.

Thus, by providing the removable HDD with secret identification information, contents can be managed even if the HDD is separated from the information processing device. Thus, the removable HDD can be used as a medium for pictures and music.

(2) Secret Key Storage Function

A secret key is registered in each removable HDD. This function is provided for an HDD that is shipped together with an exclusive device driver (secure driver) Its maker encrypts a master key in a safe place, and registers the master key in the HDD and secure driver.

FIG. 5 shows the process of such a secret key storage function. A master key 41 managed by the distribution server 35 is distributed to a maker 42 under strict management. The maker 42 encrypts the master key 41 using the DID 46 of the HDD 31 (44) and stores the key in the HDD 31 as a drive key 47.

The maker 42 also encrypts the master key 41 using software ID 48, which is the identification information of the secure driver 43 (45), and attaches the key to the secure driver as a soft key 49. For the soft ID 48, a symbol string that cannot be easily inferred is used as with the DID 46. Thus, the HDD 31 and secure driver 43, each of which share the information of the common master key 41, are shipped from the maker 42.

Thus, by providing the HDD 31 and secure driver 43 each with an encrypted master key, an authentication process and the like can be performed between the HDD 31 and secure driver 43 using the master key.

(3) Secret Communication Function (DID Reading Function)

A function to keep communication secret between the HDD and the information processing device and to make it difficult to tap their communication is provided. In FIG. 4, the secure driver 43 is installed in the OS 32, and the DID is safely received using a preset soft key 48 when the DID is read from the HDD 31. If the DID is read in a situation where there is a possibility that the communication may be tapped, a protocol for preventing re-sending is used.

FIG. 6 shows the process of a secret communication function in such an insecure place. When the application in an information processing device 51 issues a DID request 52, the secure driver 43 concatenates a soft ID 48 and a random number 53 (54), and sends it to the HDD 31.

The HDD 31 divides the concatenated information into the soft ID 48 and random number 53 (55). The HDD 31 also decrypts the drive key 47 using the DID 46 (56) and generates a master key 41. Then, the HDD 31 encrypts the master key 41 using the soft ID 48 (57) and generates a soft key.

Then, the HDD 31 calculates the exclusive-OR (XOR) of the DID 46 and random number 53 (58), and concatenates the XOR with the soft key (59). Furthermore, the HDD 31 generates a DES-MAC (Data Encryption Standard-Message Authentication Code) as the message authentication code of the concatenated information (60). Then, the HDD 31 concatenates the DES-MAC with the exclusive-OR and soft key (61), and sends them to the secure driver 43.

This DES-MAC is signature information using a DES encryption method as a hash function, and is added to transmission information for a purpose similar to a checksum. It is also sometimes called a “message digest.”

The secure driver 43 divides the received concatenated information into the exclusive-OR, DES-MAC and soft key, and generates a new DES-MAC using the XOR (62). Then, the secure driver 43 compares the generated DES-MAC with the DES-MAC received from the HDD 31 (63). If they are the same, the secure driver 43 compares the soft key received from the HDD 31 with the stored soft key 49 (64).

If the two soft keys are the same, the secure driver 43 judges that the information received from the HDD 31 is valid. Then, the secure driver 43 calculates the exclusive-OR of the XOR and random number 53 that are received from the HDD 31 (65) and extracts the DID 46. If the respective DES-MACs or soft keys are different, the secure driver 43 judges that the information received from the HDD 31 is invalid and performs an error process (66).

According to such a DID reading process, the secure driver 43 can check whether the HDD 31 has a DID 46 corresponding to the soft ID 48 and can permit the application to access the HDD 31 after it has confirmed that the HDD 31 has such a DID 46. Therefore, if another HDD with a different DID is connected to the information processing device 51, the information processing device 51 cannot access the contents of the HDD.

Since the random number conceals the soft ID 48 and DID 46 that are transferred between the HDD 21 and information processing device 51, the possibility that these pieces of secret information are stolen is reduced. Therefore, the security of the HDD 31 and information processing device 51 is ensured.

FIG. 7 shows the configuration of a content distribution system adopting the secret key storage function shown in FIG. 5 and the secret communication function shown in FIG. 6. In this system, a distribution server 35 and an information processing device 72 perform the same process as that of the information processing device 51 shown in FIG. 6 to read the DID 46 from the removable HDD 31. The HDD 31 outputs the DID 46 with signature information and the distribution server 35 and information processing device 72 identify the HDD 31 using the received DID 46.

First, the HDD 31 is connected to the information processing device 71, and sends a DID 46 in the manner shown in FIG. 6 (81). The information processing device 71 sends the DID 46 to the distribution server 35, and the distribution server 35 receives the DID 46 in the manner shown in FIG. 6 (72).

Then, the distribution server 35 encrypts a contents work key (CWK) 83 to generate an E_{DID}(CWK) using the DID 46 (84), and further encrypts contents (C) 85 to generate an E_{CWK}(C) using the CWK 83 (86). The CWK 83 is the secret key of the content owner.

The distribution server 35 sends the E_{DID}(CWK) and E_{CWK}(C) to the information processing device 71, and the information processing device 71 transfers those pieces of information to the HDD 31. Then, the HDD 31 stores the E_{DID}(CWK) and E_{CWK}(C) in the media 37.

Then, the HDD 31 is connected to another information processing device 72 and sends a DID 46 in the manner shown in FIG. 6 (81). The information processing device 72 receives the DID 46 in the manner shown in FIG. 6 (87) and decrypts the E_{DID}(CWK) using the DID 46 to generate a CWK 73 (88). Then, the information processing device 72 further decrypts the E_{CWK}(C) using the CWK 73 (89). Then, the information processing device 72 extracts the contents 85 and displays it on the screen 90.

According to such a distribution system, the information processing device 71 cannot directly access the DID 46, CWK 73 or contents 85. Therefore, even if the information processing device 71 is not trusted, the illegal use of these pieces of information can be prevented. However, the information processing device 72 corresponds to a trusted device that can be used to reproduce the contents 85.

(4) User Management Function

This function stores the name and password of the user of the HDD, and sets reading/writing privileges for each user. This function can also set an attribute for each user.

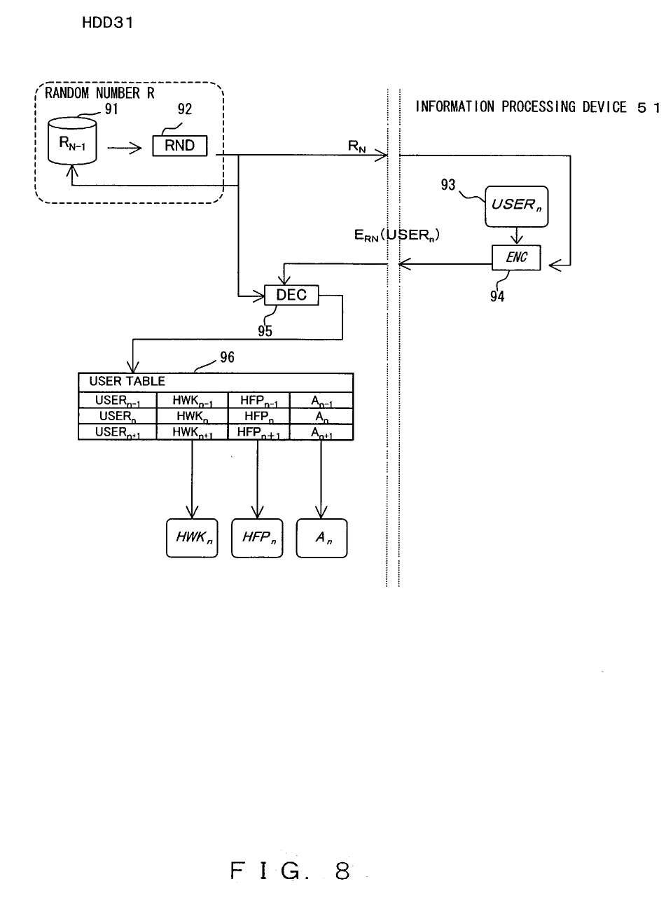

FIG. 8 shows the process of such a user management function. The HDD 31 generates a random number R_{N} for preventing re-sending using a previously sent random number R_{N-1} which is stored in a random number storage unit 91, as an initial value, and sends the random number R_{N} to an information processing device 51. The sent R_{N} is stored in the random number storage unit 91.

The information processing device 51 encrypts user identification information (user name) 93 (USERₙ) to generate an E_{RN}(USERₙ) using the received R_{N} as a key (94). Then, the information processing device 51 transfers the E_{RN}(USERₙ) to the HDD 31.

The HDD 31 decrypts the received E_{RN}(USERₙ) using the R_{N} to generate a USERₙ. Then, the HDD 31 extracts a host work key HWKₙ corresponding to the USERₙ, host fixed pattern HFPₙ and user attribute Aₙ from a user table 96 on the media 37, and uses them in the subsequent processes.

The HWKₙ is a secret key stored in the information processing device 51, and the HFPₙ is a fixed value for disturbance, which is used in DES. The Aₙ corresponds to information about a group to which a user belongs and the like.

By providing such a user table 96, a host work key, a host fixed pattern and a user attribute can be set for each user, and contents management becomes possible for each user by using these pieces of information.

(5) Reciprocal Authentication Function

The removable HDD and information processing device each checks whether their partner has the same host work key as their own host key using a host work key registered in advance and authenticates the partner.

FIG. 9 shows the process of such a reciprocal authentication function. The HDD 31 and information processing device 51, first, exchange their random numbers for preventing re-sending, and then exchanges their host fixed patterns. If their respective random numbers and host fixed patterns are the same, the authentication is completed and a reading/writing operation is started. The HDD 31 does not start a reading/writing operation until the authentication has completed.

First, the information processing device 51 encrypts a random number R1 to generate an E_{HWK}(R1) using a HWK 101 stored in advance (102). Then, the information processing device 51 transfers the E_{HWK}(R1) to the HDD 31.

The HDD 31 decrypts the E_{HWK}(R1) using a HWK 103 extracted from a user table (104). Then, the HDD 31 encrypts a random number R2 to generate an E_{HWK}(R2) using the HWK 103 (105). Then, the HDD 31 sends the E_{HWK}(R2) to the information processing device 51.

The HDD 31 also calculates the exclusive-OR of a HFP 106 extracted from the user table and the result (R1) of decryption 104 (107) and encrypts the XOR to generate an E_{HWK}(R1 xor HFP) using the HWK 103 (108). Then, the HDD 31 sends the E_{HWK}(R1 xor HFP) to the information processing device 51.

The information processing device 51 decrypts the E_{HWK}(R2) using the HWK 101 (109) and calculates the exclusive-OR of the result of the decryption (R2) and an HFP 110 stored in advance (111). Then, the information processing device 51 encrypts the XOR to generate an E_{HWK}(R2 xor HFP) using the HWK 101 (112). Then, the information processing device 51 transfers the E_{HWK}(R2 xor HFP) to the HDD 31.

The information processing device 51 also decrypts the E_{HWK}(R1 xor HFP) received from the HDD 31 using the HWK 101 and calculates the exclusive-OR of the result of the decryption (R1 xor HFP) and the HFP 110 (114). Then, the information processing device 51 compares the XOR 114 with R1 (115) and performs authentication judgment (116), If the XOR and R1 are the same, it is detected that the HDD 31 stores the same HWK and HFP. Therefore, the information processing device 51 authenticates the HDD 31 as a correct partner. If they are different, the information processing device 51 does not authenticate the HDD 31.

The HDD 31 decrypts the E_{HWK}(R2 xor HFP) received from the information processing device 51 using the HWK 103 (117), and calculates the exclusive-OR of the result of the decryption (R2 xor HFP) and the HFP 106 (118). Then, the HDD 31 compares the XOR generated at 118 with R2 (119) and performs authentication judgment (120). If the XOR and R2 are the same, it is detected that the information processing device 51 stores the same HWK and HFP. Therefore, the HDD 31 authenticates the information processing device 51 as a correct partner. If they are different, the HDD 31 does not authenticate the information processing device 51.

According to such an authentication method, not only the information processing device 51 can authenticate the HDD 31, but the HDD 31 can also authenticate the information processing device 51. The HDD 31 does not permit the information processing device 51 to access its contents if the information processing device 51 is not authenticated. Therefore, illegal access by the information processing device 51 can be prevented.

The information processing device 51 cannot access the contents of the HDD 31 and read/write data until both devices have authenticated each other.

The OS 32 shown in FIG. 4 corresponds to the OS of the information processing device authenticated by the HDD 31. The information processing device 51 shown in FIG. 6 or the information processing device 72 shown in FIG. 7 corresponds to the information processing device authenticated by the HDD 31. The information processing device 71 shown in FIG. 7 or the information processing device 51 shown in FIG. 8 corresponds to the unauthenticated information processing device.

(6) Clock Function

The removable HDD is provided with a built-in clock and manages the expiration time of each license. Its management targets are sectors, files and the like.

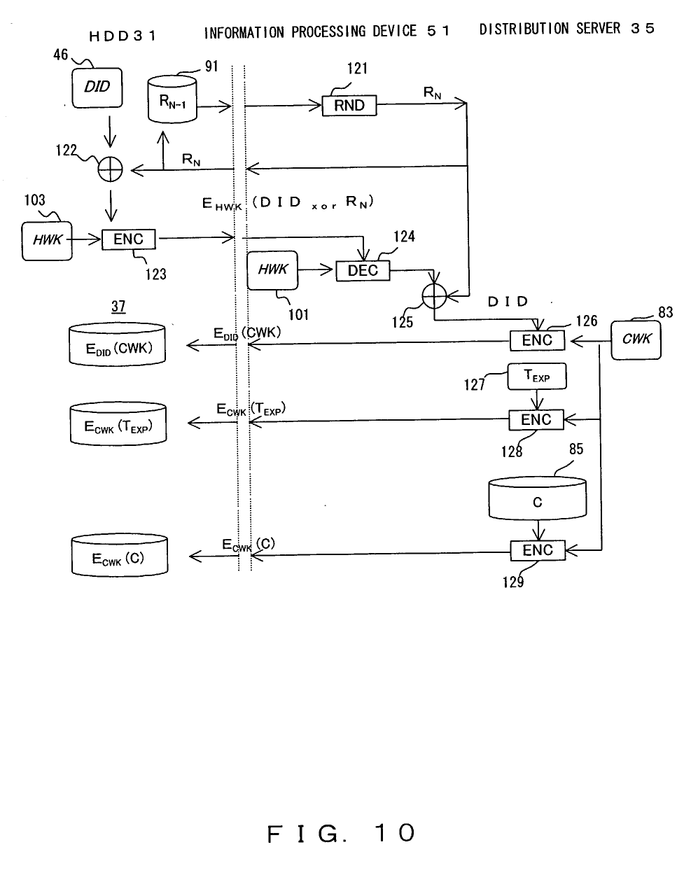

FIG. 10 shows the registration process of a license with expiration time that is employed by such a clock function. In this process, the DID 46 of the HDD 31 is encrypted and is sent to the distribution server 35 through the information processing device 51. The distribution server 35 encrypts a contents work key 83, a contents expiration time 127 and the contents themselves 85 and writes them in the HDD 31. This expiration time 127 corresponds to a license with expiration time.

First, the HDD 31 extracts a random number R_{N-1} from a random number storage unit 91 and sends the R_{N-1} to the authenticated information processing device 51. The information processing device 51 generates a random number for preventing re-sending R_{N} using the received R_{N-1} as an initial value (121) and returns the R_{N} to the HDD 31.

The HDD 31 calculates the exclusive-OR of the DID 46 and R_{N} (122), and encrypts the XOR to generate an E_{HWK}(DID xor R_{N}) using the HWK103 (123). Then, the HDD 31 sends the E_{HWK}(DID xor R_{N}) to the information processing device 51.

The information processing device 51 decrypts the received E_{HWK}(DID xor R_{N}) using the HWK 101 (124) and calculates the exclusive-OR of the result of the decryption (DID xor R_{N}) and R_{N} to generate a DID 46 (125). Then, the information processing device 51 sends the obtained DID 46 to the distribution server 35.

The distribution server 35 encrypts a CWK 83 to generate an E_{DID}(CWK) using the received DID 46 (126). The distribution server 35 encrypts an expiration time 127 (T_{EXP}) and contents 85 (C) using the CWK 83 to generate an E_{CWK}(T_{EXP}) and an E_{CWK}(C) (128 and 129). Then, the distribution server 35 sends these pieces of information to the information processing device 51. The information processing device 51 transfers the received information to the HDD 31. The HDD 31 stores the E_{DID}(CWK), E_{CWK}(T_{EXP}) and E_{CWK}(C) in the media 37.

Thus, the contents expiration time is registered in the HDD 31 together with the contents work key and contents. In FIG. 10, although the random number storage unit 91 is installed in the HDD 31, it could also be installed in the information processing device 51.

If this HDD 31 is connected to an authenticated information processing device, the information processing device cannot read the DID 46 as shown in FIG. 7. However, the information processing device can read the contents work key and reproduce the contents. In this case, information about the expiration time 127 is decrypted in the HDD 31 and it is checked whether the expiration time has already expired.

FIG. 11 shows the decryption process of such a license with expiration time. In this process, the expiration time T_{EXP} decrypted in the HDD 31 and the time T_{NOW} of a built-in clock 134 are compared. If the expiration time has already expired, the contents work key is not sent.

When being connected to an unauthenticated information processing device 131, the HDD 31, first, sends the E_{DID}(CWK) and E_{CWK}(T_{EXP}) to the information processing device 131. The information processing device 131 returns these pieces of information to the HDD 31 without modifying them.

Then, the HDD 31 decrypts the E_{DID}(CWK) using the DID 46 to generate a CWK (132). Then, the HDD31 decrypts the E_{CWK}(T_{EXP}) using the obtained CWK to generate a T_{EXP} (133). Then, the HDD 31 compares the obtained T_{EXP} with the time T_{NOW} of the built-in clock 134 (135).

If the T_{NOW} is earlier than the T_{EXP}, the expiration time has not yet expired. Therefore, the HDD 31 sends the CWK to the information processing device 131 (136). If the T_{NOW} is equal to or later than the T_{EXP}, the expiration time has already expired. Therefore, the HDD31 does not send the CWK to the information processing device 131.

On receipt of the CWK, the information processing device 131 reads the E_{CWK}(C) from the HDD 31. Then, the HDD 31 decrypts the E_{CWK}(C) using the CWK, extracts the contents C and displays the contents C on the screen 90.

By providing such a clock function, a license can be stored in the media 37 and managed. Thus, even when the information processing device to which the HDD 31 is connected changes, the HDD 31 can retain the license.

(7) Sector Management Function

This function sets read/write rights and expiration time for each sector of a removable HDD, and manages data recorded on a medium per sector.

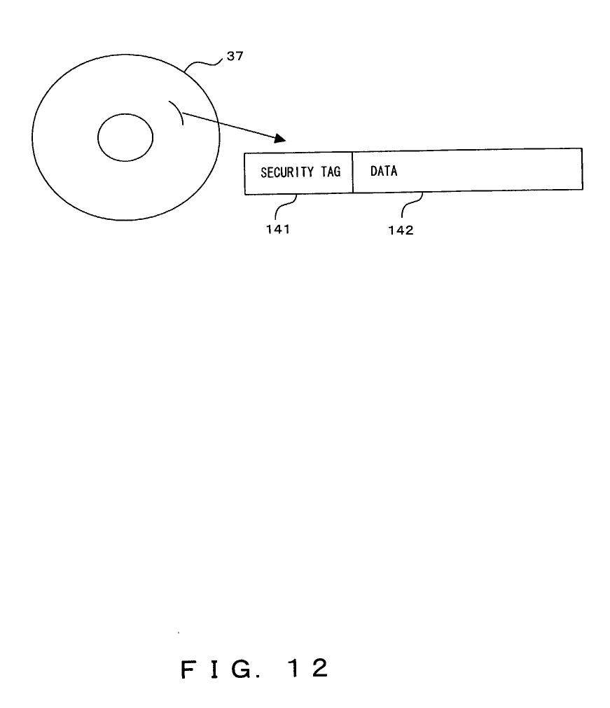

FIG. 12 shows the logical structure of one sector (logical sector), which is the minimum recording unit of the media 37. Each sector is provided with a security tag 141, and by setting restrictions on access to data 142 using this tag 141, security can be enforced. The following pieces of information are recorded on the security tag.

(a) Identification information of the owner (user) of the sector

(b) Expiration time

(c) Read/write restrictions for users other than the owner

(d) Read/write restrictions for a group to which the owner belongs

In order to distinguish the owner of a sector from the others, a HDD uses the user management function shown in FIG. 8 and reciprocal authentication function shown in FIG. 9 together. An information processing device checks whether a user who wants to use the HDD is registered in the user table 96 shown in FIG. 8. If the user is not yet registered, the information processing device registers the user in the user table 96. In this case, the information processing device simultaneously registers a host work key and a host fixed pattern that are used for reciprocal authentication and a user attribute together with the user identification information. The processes of the registration and reciprocal authentication are as follows.

(a) An information processing device checks whether host work key, host fixed pattern and the user attribute corresponding to user identification information are registered on a HDD, based on the user identification information.

(b) If they are not yet registered, the information processing device registers those pieces of information in the HDD.

(c) The HDD authenticates the information processing device using the registered host work key and host fixed pattern, and the information processing device accesses the HDD (encryption communication).

(d) A user can access his/her sectors and unowned sectors, and simultaneously can set access restrictions. Access to each sector owned by another of the user is subject to the set restrictions. In this case, sectors on which the reading/writing restrictions for a group of the user are set, can be read/written under the restrictions.

(e) The user can separate the HDD from the information processing device with his/her host work key and host fixed pattern registered. If the HDD is separated from the information processing device, the situation where the HDD and information processing device authenticate each other is released and they are restored to an unauthenticated state.

(f) If the host work key and host fixed pattern are deleted from the HDD, the data on the user's sector is deleted. Then, the ownership of the sector is cancelled. If the expiration time of a sector has expired, the data and access restrictions of the sector are removed.

Each user is a manager who manages his/her host work key and host fixed pattern and the HDD receives these pieces of information from each user. According to such a sector management function, data can be managed for each sector. Therefore, a plurality of contents can be stored on one HDD. Furthermore, since a different owner can be set for each sector, a plurality of users can securely share one HDD.

Next, the configuration and operation of a removable HDD are described in detail below with reference to FIGS. 13 through 32.

FIG. 13 shows the configuration of the removable HDD 31. The HDD shown in FIG. 13 comprises a PCA (printed circuit board) 151 and a DE (disk enclosure) 152.

The PCA 151 further comprises a CPU (central processing unit) 161, a CLOCK (built-in clock) 162, a RAM (random-access memory) 163, a MASKROM (read-only memory) 164, an I/F (interface) 165, an HDC (hard disk control circuit) 166, an SVC (servo circuit) 167 and an RDC (read channel) 168.

The DE 152 further comprises media 37, an SPM (spindle motor) 171, a VCM (voice coil motor) 172, a head 173 and a PREAMP (preamplifier) 174.

The MASKROM 164 of the PCA 151 is a read-only memory, and stores firmware (program) for controlling the operation of the HDD. The CPU 161 is a processor, and controls the operation of the HDD by using the RAM 163 and executing the program stored in the MASKROM 164. The clock 162 corresponds to the built-in clock 134 shown in FIG. 11, and runs on a battery. The I/F 165 is an ATA (AT attachment) interface communicating with a connected information processing device.

The HDC 166 is an aggregate of a security function and a variety of control circuits. The SVC 167 keeps the rotation of the SPM 171 constant and controls the position of the head 173. The RDC 168 converts analog signals from the DE 152 into digital signals.

The media 37 of the DE 152 is magnetic disks (disks coated with magnetic material), and the SPM 171 is a motor rotating the media 37. The VCM 172 is composed of a coil and a magnet that operate the head 173. The head 173 reads/writes the magnetic pattern from/onto the media 37 as analog signals, and the PREAMP 174 amplifies the analog signals of the head 173. Data are exchanged between the PCA 151 and DE 152 through the RDC 168 and PREAMP 174.

If an HDD is used in the form shown in FIG. 3, the PCA 151 can be built into an information processing device. In this case, the HDD can comprise only the DE 152. The secure module 36 shown in FIG. 4 corresponds to the PCA 151.

The MASKROM 164 stores firmware as shown in FIG. 14. An INIT (initial setting section) 181 sets values needed by the hardware by making a variety of initial settings, and a CKSM (checksum section) 182 checks the propriety of the firmware itself prior to starting it. A CMD (command analysis section) 183 receives/interprets commands and executes necessary routines.

An FRW (firmware rewriting section) 184 judges whether the firmware can be rewritten and rewrites the firmware, and a DES (DES section) 185 encrypts/decrypts data. A MAC (encryption checksum section) 186 generates DES-MAC values, and a USR (user section) 187 registers and manages users.

An AUT (authentication section) 188 authenticates information processing devices, and a DID (drive ID section) 189 sends DIDs. A SEEK (seek section) 190 controls the position of the head 173, and a READ (reading unit) 191 reads sectors. A WRITE (writing section) 192 writes data onto a sector, and an OTHERS 193 has other infrastructure functions needed to operate the HDD.

The firmware is stored in the system area (SA) of the media 37, and at the time of power-on, a firmware loader loads the firmware into the MASKROM 164.

Next, a non-volatile function provided for an HDD in order to realize the identification function shown in FIG. 4, secret key storage function shown in FIG. 5 and reciprocal authentication function shown in FIG. 9 is described below. The non-volatile function generates a read-only memory area (secure area) in the media 37 in order to store DIDs. For the installation method of the non-volatile function, a method for replacing firmware or a head between before and after the shipment of an HDD can be used.

According to a method for replacing firmware, a pseudo-non-volatile area in which data cannot be written in the field after shipment can be realized on the medium by combining the specifications of firmware and its loader and replacing firmware in a specific order in its manufacturing process.

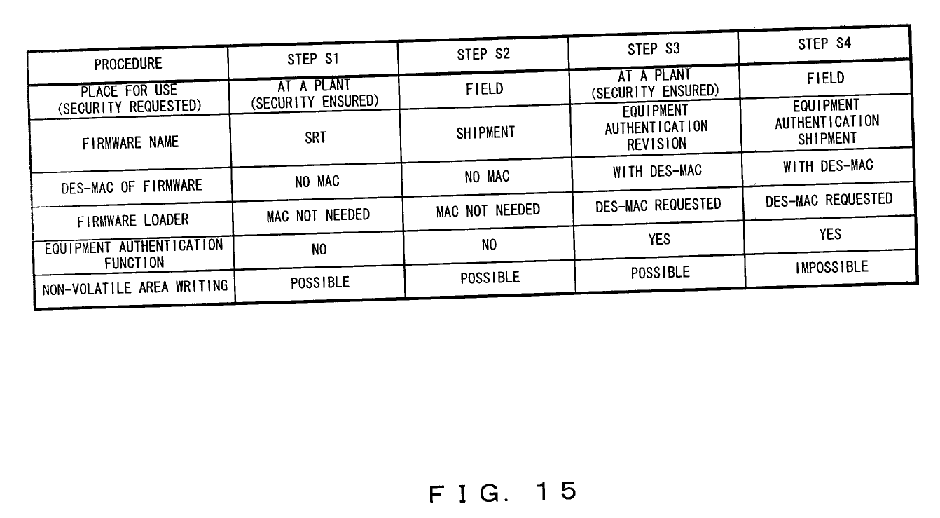

FIG. 15 shows the specifications of four pieces of firmware installed in an HDD in order.

In steps S1, S2, S3 and S4, SRT firmware, shipment firmware, equipment authentication revision firmware and equipment authentication shipment firmware, respectively are used. Of these pieces of firmware, the SRT firmware and equipment authentication revision firmware are used only at the manufacturing plant where security has been ensured.

Although the SRT firmware, shipment firmware and equipment authentication revision firmware can write data in a non-volatile area, the equipment authentication shipment firmware cannot write data in a non-volatile area.

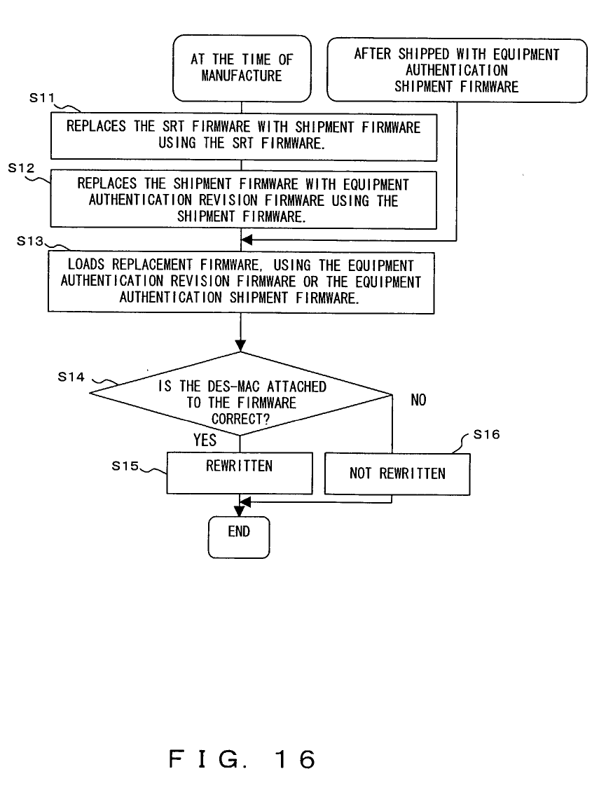

FIG. 16 is a flowchart showing the rewriting procedure of these pieces of firmware. Steps S1 and S2 in FIG. 15 correspond to steps S11 and 12 in FIG. 16. Steps S3 and S4 in the FIG. 15 correspond to step S13 in FIG. 16.

At the time of manufacture, first, the SRT firmware is rewritten into shipment firmware by the SRT firmware itself (step S11), and the shipment firmware is rewritten into equipment authentication revision firmware by the shipping firmware itself (step S12). Then, the equipment authentication shipment firmware is loaded by the equipment authentication revision firmware (step S13), and it is checked whether a DES-MAC accompanying the equipment authentication shipment firmware is correct (step S14).

If the DES-MAC is correct, the equipment authentication revision firmware is rewritten into the equipment authentication shipment firmware (step S15), and an HDD with the non-volatile function is shipped to the field. If the DES-MAC is not correct, the firmware is not be rewritten (step S16). The DES-MAC check method is described later.

If it becomes necessary to write data in a non-volatile area after the equipment authentication shipment firmware is installed in a HDD and the HDD has shipped, the equipment authentication shipment firmware is replaced with equipment authentication revision firmware.

In this case, the equipment authentication revision firmware is loaded by the equipment authentication shipment firmware (step S13), and the DES-MAC is checked (step S14). If the DES-MAC is correct, the equipment authentication shipment firmware is rewritten into equipment authentication revision firmware (step S15). If the DES-MAC is not correct, the firmware is not be rewritten (step S16).

According to a method for replacing a head, a physically unrewritable area is generated by utilizing the positional deviation between the reading core and writing core of the head and using two heads each with a different deviational direction.

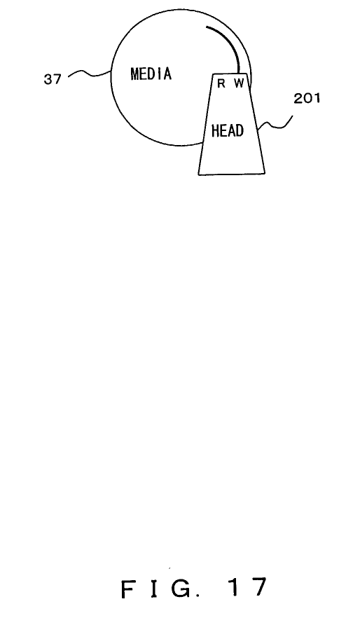

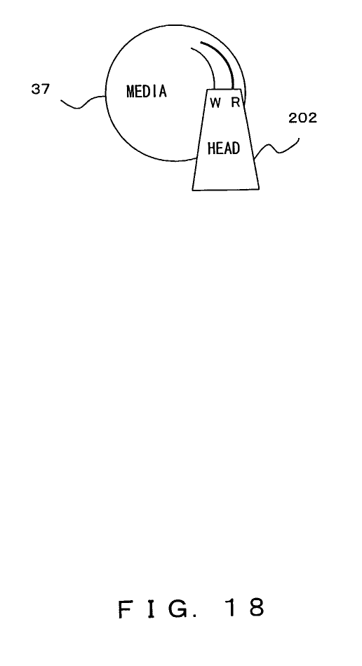

At the time of manufacture, first, as shown in FIG. 17, a DID is written in the outermost circumference of the media 37 using a head 201 with a writing core (W) located on the outer side. Then, as shown in FIG. 18, the head 201 is replaced with a head 202 with a reading core (R) and a writing core (W) located on the outer side and inner side, respectively, and the HDD is shipped with this head 202. Thus, the outermost circumference of the media 37 is made into a non-volatile area where data can be read but cannot be written, and the DID cannot be rewritten in the field.

Next, the work key generation function used in the secret key storage function shown in FIG. 5 is described. The work key generation function encrypts a master key 41 using a DID 46 and generates a drive key 47.

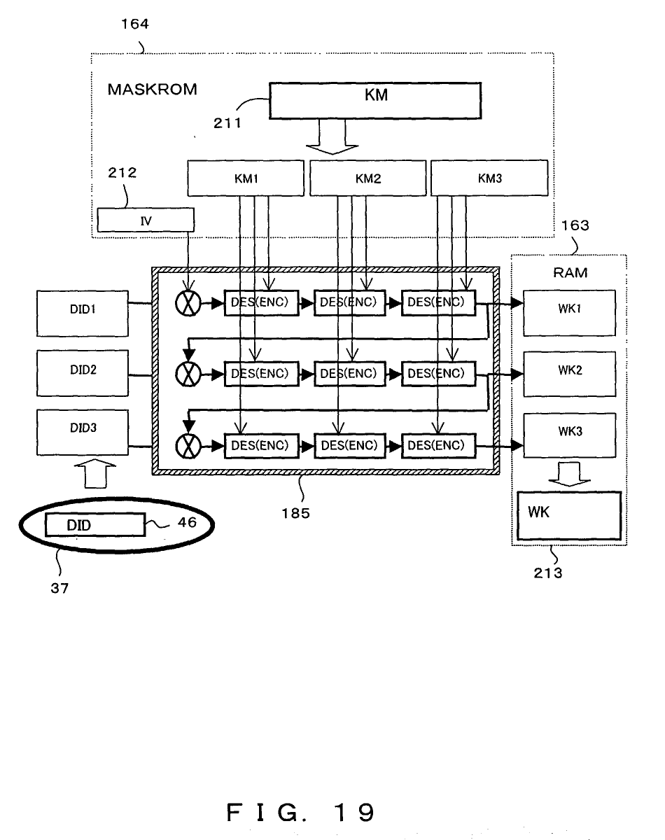

FIG. 19 shows the work key generation process performed by the DES 185 shown in FIG. 14. A master key (KM) 211 and a work key (WK) 213 correspond to the master key 41 and drive key 47, respectively, shown in FIG. 5, and an IV 212 is a predetermined fixed value.

The DES 185, first, evenly divides the KM 211 to generate a KM1, a KM2 and a KM3. Then, the DES 185 evenly divides the DID 46 read from the media 37 to generate a DID1, a DID2 and a DID3. Then, a WK1, a WK2 and a WK3 are generated by a triple DES method using the exclusive-OR of the IV 212 and DID1 as an initial value. Then, a WK 213 is generated by concatenating the WK1, WK2 and WK3.

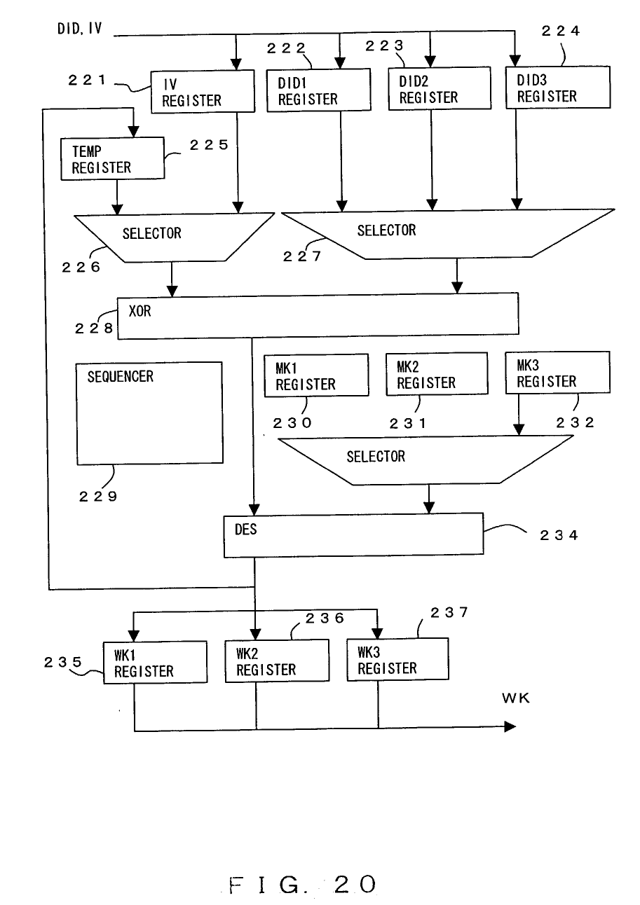

FIG. 20 shows the configuration of a work key generation circuit with the same function as that of the DES 185. Such a circuit can also be provided for the PCA 151 instead of the DES 185. An IV register 221, a DID1 register 222, a DID2 register 223 and a DID3 register 224 store the IV 212, DID1, DID2 and DID3, respectively.

A selector 226 selects the value of a TEMP register 225 or that of the IV register 221, and a selector 227 selects the value of the DID1 register 222, that of the DID2 register 223 or that of the DID3 register 224. An XOR 228 calculates the exclusive-OR of the respective outputs of the selectors 226 and 227.

An MK1 register 230, an MK2 register 231 and an MK3 register 232 store the values of MK1, MK2 and MK3, respectively. A selector 233 selects the value of the MK1 register 230, the MK2 register 231 or the MK3 register 232.

A DES 234 executes the DES type encryption operation using the respective outputs of the XOR 228 and selector 233, and stores the result of the operation in the TEMP register 225, WK1 register 235, WK2 register 236 and WK3 register 237. A sequencer 229 controls the respective operation sequences of the selectors and registers.

Although in FIGS. 19 and 20, the generation method of the drive key 47 shown in FIG. 5 has been described, the soft key 49 shown in FIG. 5 is also generated by the a similar firmware or circuit.

Next, an encryption checksum function used in the secret communication function shown in FIG. 6 is described. The encryption checksum function generates the DES-MAC used to prevent the alteration of a program. When recording program code on a medium, an HDD attaches in advance a correct MAC value to the code and compares the MAC value generated prior to execution and the recorded MAC value. If the two MAC values are different, the HDD judges that the program code has been altered and does not execute the program code.

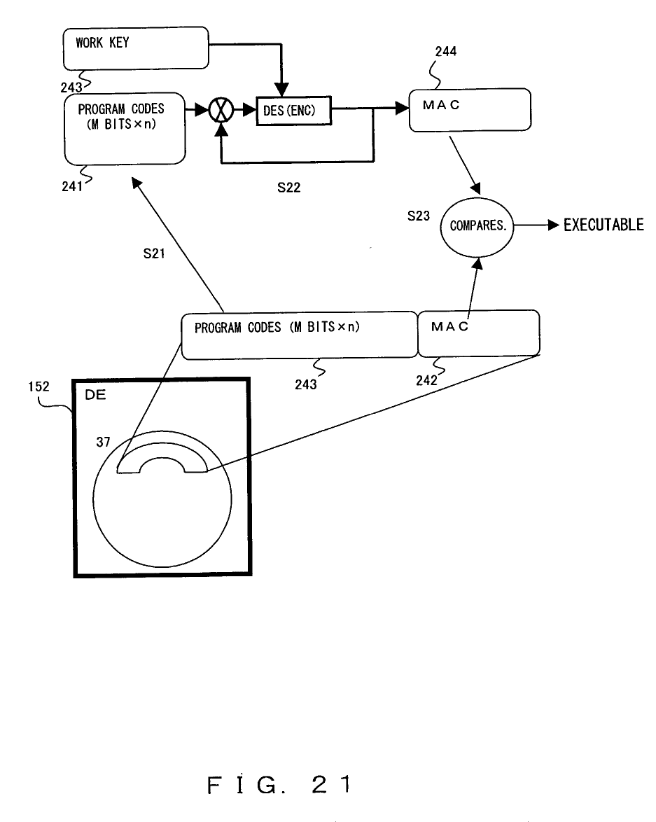

FIG. 21 shows an encryption checksum process performed by the MAC 186 shown in FIG. 14. The MAC 186, first, loads program code 241 recorded on the media 37 into a RAM 163 (step S21), and generates a MAC 244, based on the program code 241 and a work key 243 (step S22).

In this case, the MAC 186 divides the program code 241 into n of M bits, applies the DES type encryption operation to the first M bits and designates the result as a MAC value. The MAC 186 calculates the exclusive-OR of the second M bits and the MAC value generated based on the first M bits, applies an encryption operation to the XOR and generates a new MAC value. Thus, after repeating the encryption operation n times, the MAC 244 is generated.

Then, the MAC 186 compares the obtained MAC 244 with the MAC 242 recorded on the media 37 (step S23). If the MAC 244 and MAC 242 are the same, the MAC 186 outputs the judgment that the program code 241 is executable. If the MAC 244 and MAC 242 are different, the MAC 186 outputs the judgment that the program code 241 is not executable.

In the case of FIG. 6, a DES-MAC is generated using the value of “Soft Key//RANDOM xor Drive ID” instead of the program code 241 (60) and is sent from the HDD 31.

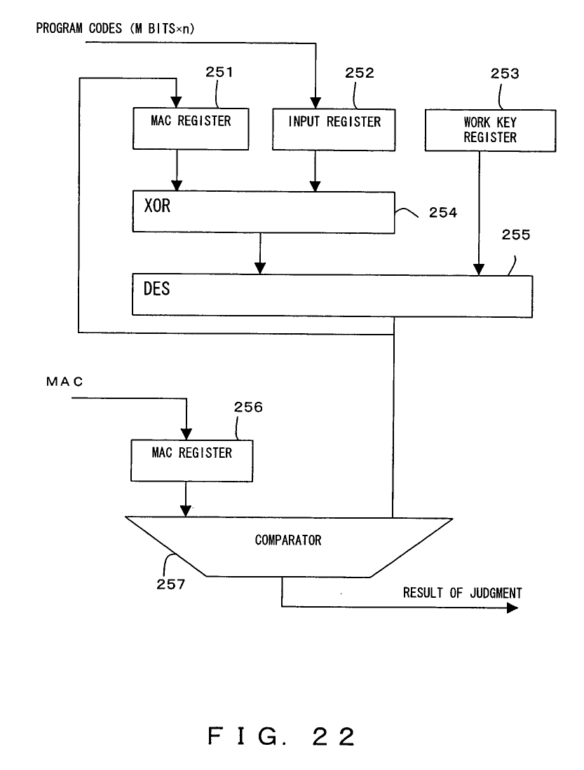

FIG. 22 shows the configuration of an encryption checksum circuit with the same function as that of the MAC 186. Such a circuit can also be provided for the PCA 151 instead of the MAC 186. A MAC register 251, an input register 252 and a work key register 253 store the generated MAC value, program code 241 and work key 243, respectively.

An XOR 254 calculates the exclusive-OR of the value of the MAC register 251 and that of the input register 252. A DES 255 executes a DES type encryption operation using the result of the calculation of the XOR 254 and the value of the work key register 253, and stores the result in the MAC register 251. Then, after repeating the encryption operation n times, the DES 255 outputs a MAC 244.

A MAC register 256 stores the MAC 242. A comparator 257 compares the value of the MAC register 256 and the MAC 244 output from the DES 255, and outputs the result as a result of judgment.

Next, the user registration function used in the user management function shown in FIG. 8 is described. The user registration function registers users in the user table 96 shown in FIG. 8.

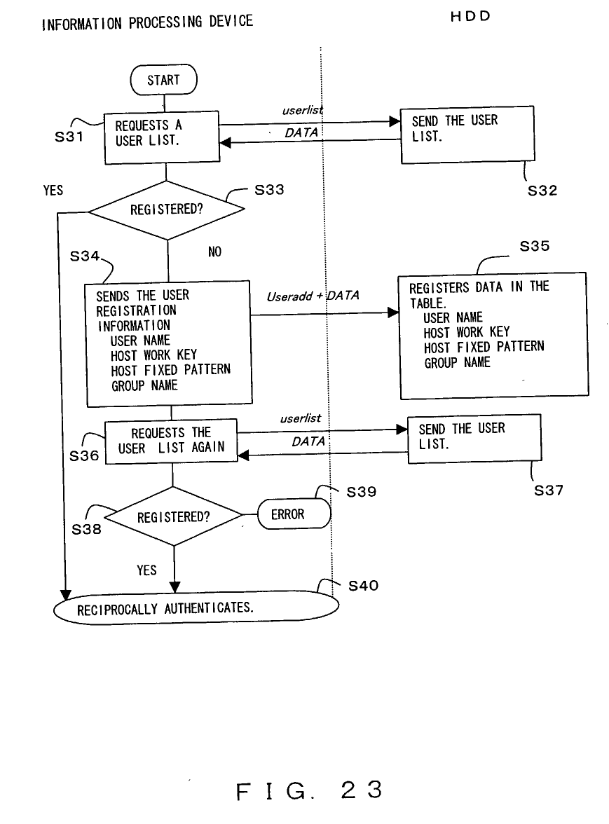

FIG. 23 shows a user registration process by the USR 187 shown in FIG. 14 and an information processing device. This process is performed when a user inputs his/her user name to the information processing device in order to use an HDD.

First, the information processing device requests the HDD to send a user list (step S31), and the USR 187 of the HDD returns a list of user names registered in a user table (step S32). Then, the information processing device refers to the received list and checks whether the input user name is already registered in the HDD (step S33). If the user name is already registered, the information processing device performs the reciprocal authentication process shown in FIG. 9 (step S40).

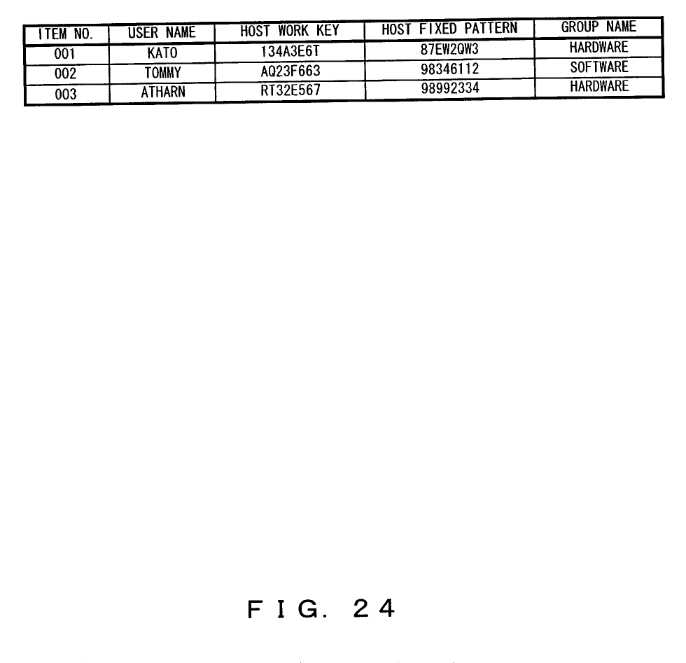

If the user name is not yet registered, the information processing device transfers the user name, host work key, host fixed pattern and group name to the HDD as user registration information, and requests the HDD to register the data in the user table (step S34). Then, the USR 187 registers the received information in the user table (step S35). Thus, the user table shown in FIG. 24 is generated.

Then, the information processing device request the HDD to send the user list again (step S36), and the USR 187 returns the updated user list (step S37). Then, the information processing device checks whether the input user name is registered (step S38). If the user name is registered, the information processing device performs the process in step S40. If the user name is not registered, the information processing device performs an error process (step S39).

Next, the reciprocal authentication function shown in FIG. 9 is described in more detail. By this function, an information processing device and an HDD are reciprocally authenticated using a host work key and a host fixed pattern, which a user sets.

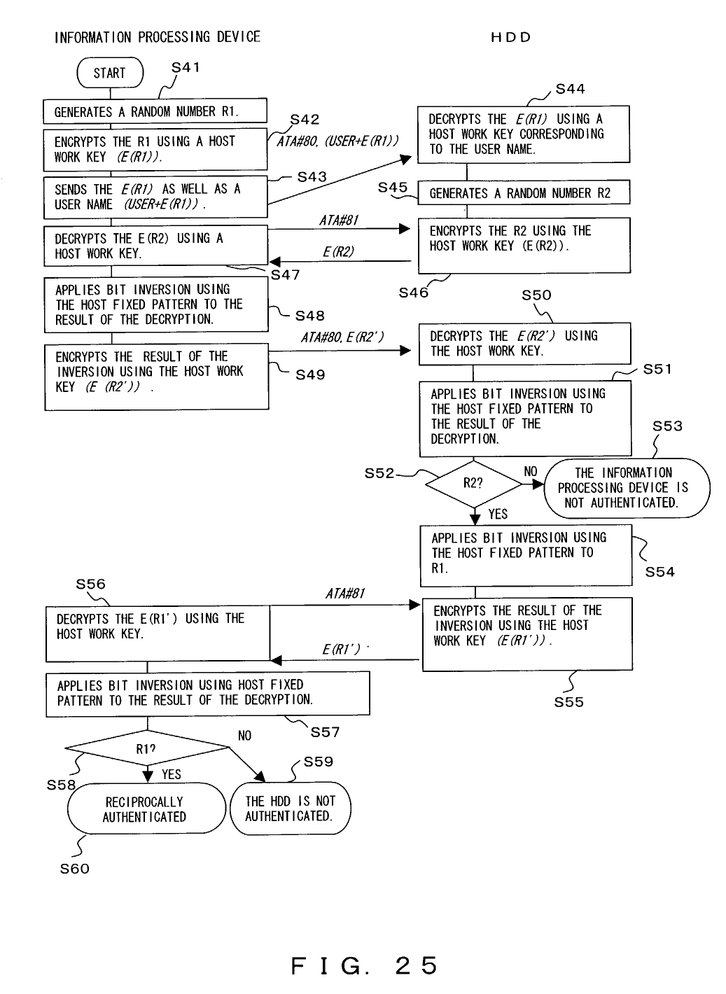

FIG. 25 is the sequence chart of such a reciprocal authentication function. A user name, a host work key and a host fixed pattern are registered in advance in the information processing device and the HDD. An ATA #80 is an encryption sending command (interface) and an ATA #81 is an encryption receiving command.

First, the information processing device generates a random number R1 (step S41), and encrypts the R1 using the host work key to generate an E(R1) (step S42). Then, the information processing device sends the E(R1) to the HDD together with the user name USER (step S43).

The HDD decrypts the E(R1) using a host work key corresponding to the user name (step S44). Then, the HDD generates a random number R2 (step S45), and encrypts the R2 using the host work key to generate an E(R2) (step S46). Then, the HDD sends the E(R2) to the information processing device.

The information processing device decrypts the E(R2) using the host work key (step S47), applies bit inversion using the host fixed pattern to the result of the decryption (step S48) and encrypts the result of the inversion using the host work key to generate an E(R2′) (step S49). Then, the information processing device sends the E(R2′) to the HDD.

The HDD decrypts the E(R2′) using the host work key (step S50), applies bit inversion using the host fixed pattern to the result of the decryption (step S51) and compares the result of the inversion with R2 (step S52). If the result of the inversion and R2 are different, the HDD does not authenticate the information processing device (step S53).

If the result of the inversion and R2 are the same, the HDD authenticates the information processing device. Then, the HDD applies bit inversion using the host fixed pattern to the R1 restored in step S44 (step S54). Then, the HDD encrypts the result of the inversion using the host work key to generate an E (R1′) (step S55) and sends the E(R1′) to the information processing device.

The information processing device decrypts the E(R1′) using the host work key (step S56), applies bit inversion using the host fixed pattern to the result of the decryption (step S57) and compares the result of the inversion with R1 (step S58). If the result of the inversion and R1 are different, the information processing device does not authenticate the HDD (step S59). If the result of the inversion and R1 are the same, the information processing device authenticates the HDD, and the HDD and information processing device enter a reciprocally authenticated relationship (step S60).

If the program of the information processing device and AUT 188 shown in FIG. 14 jointly perform such a process, for example, the reciprocal authentication shown in FIG. 9 is made. However, if this process is realized by hardware, the reciprocal authentication mechanism shown in FIG. 26 is used.

In the reciprocal authentication mechanism shown in FIG. 26, the PAC 151 of the HDD comprises a host fixed pattern register 261, a host work key register 262, a random number R2 module 263 and a fixed pattern module 264 instead of the AUT 188.

The information processing device comprises a host fixed pattern register 271, a host work key register 272, a random number R1 module 273 and a fixed pattern module 274.

Each of the host fixed pattern registers 261 and 271 stores a host fixed pattern HFP, and each of the host work key registers 262 and 272 stores a host work key HWK. On receipt of a start signal 275, the random number R1 module 273 generates a random number R1 and sends an E_{HWK}(R1) to the random number R2 module 263.

The random number R2 module 263 decrypts the E_{HWK}(R1) and transfers R1 to the fixed pattern module 264. The random number R2 module 263 also generates a random number R2 and sends an E_{HWK}(R2) to the random number R1 module 273. Then, the random number R1 module 273 decrypts the E_{HWK}(R2) and transfers R2 to the fixed pattern module 274. The fixed pattern module 274 generates an E_{HWK}(R2 xor HFP) using the R2, HFP and HWK, and sends the E_{HWK}(R2 xor HFP) to the fixed pattern module 264.

The fixed pattern module 264 extracts R2 from the E_{HWK}(R2 xor HFP), compares the R2 with the R2 generated by the random number R2 module 263, and outputs the result of the judgment. The fixed pattern module 264 also generates an E_{HWK}(R1 xor HFP) using the R1, HFP and HWK, and sends the E_{HWK}(R1 xor HFP) to the fixed pattern module 274.

The fixed pattern module 274 extracts R1 from the E_{HWK}(R1 xor HFP), compares the R1 with the R1 generated by the random number R1 module 273, and outputs the result of the judgment.

Then, a DID sending function used in the identification function shown in FIG. 4 is described. Although in the secret communication function shown in FIG. 6, an information processing device reads a DID from an HDD using a soft ID, the HDD can also provide the information processing device with a DID using a host work key and a host fixed pattern set by a user.

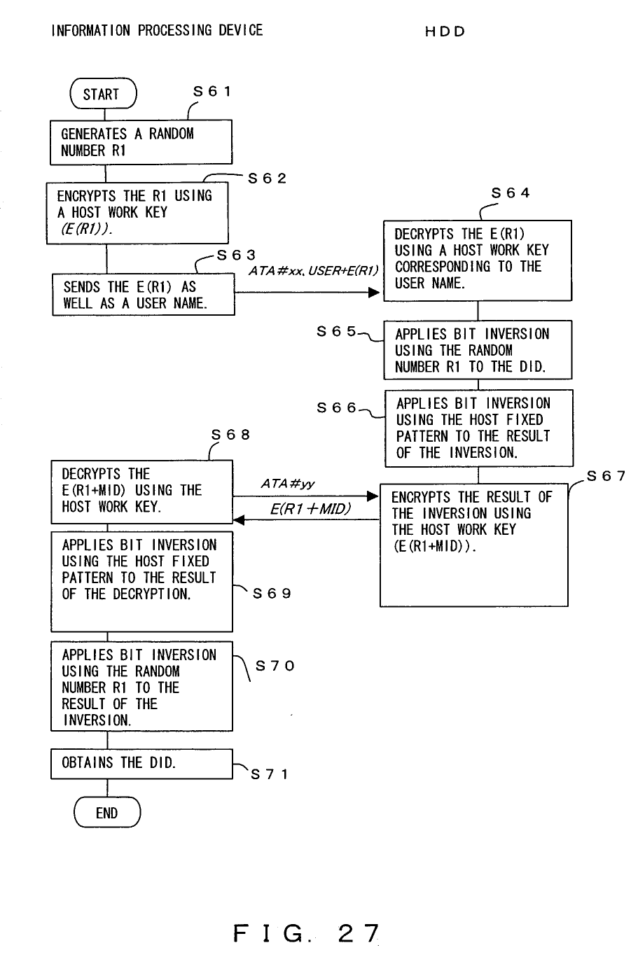

FIG. 27 is the sequence chart of such a DID sending function. It is assumed that a user name, a host work key and a host fixed pattern are registered in an information processing device and an HDD, and that the reciprocal authentication between the information processing device and HDD has already been completed. An ATA#xx is an encryption sending command (interface), and an ATA#yy is an encryption receiving command.

The sequence of steps S61 through S64 shown in FIG. 27 is similar to that of steps S41 through S44 shown in FIG. 25. When obtaining a random number R1 from the E(R1), the HDD applies bit inversion using R1 to a DID (step S65) and further applies bit inversion using the host fixed pattern to the result of the inversion (step S66) to generate an MID. Then, the HDD concatenates R1 and MID, encrypts the concatenated R1 and MID using the host work key to generate an E(R1+MID) (step S67) and sends the E(R1+MID) to the information processing device.

The information processing device decrypts the E(R1+MID) using the host work key (step S68). Then, the information processing device applies bit inversion using the host fixed pattern to MID (step S69), and further applies bit inversion using R1 to the result of the inversion (step S70) to obtain a DID (step S71).

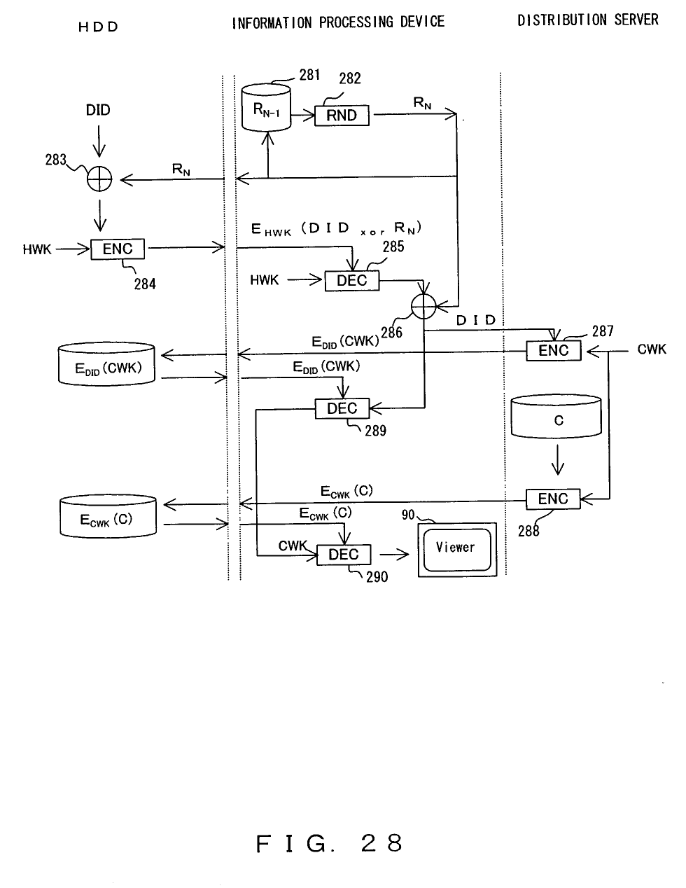

If the program of the information processing device and the firmware of the HDD jointly perform such a process, for example, the DID sending process shown in FIG. 28 is performed.

However, in the process shown in FIG. 28, an R_{N} is used instead of the random number R1 and it is assumed that the bits of the host fixed pattern are all 0. In this case, since the exclusive-OR of a given pattern P and the host fixed pattern remains P, this calculation is omitted.

First, the information processing device extracts a random number R_{N-1} from a random storage unit 281 and generates a random number R_{N} for preventing re-sending using the R_{N-1} as an initial value (282). Then, the information processing device transfers the R_{N} to the HDD.

The HDD calculates the exclusive-OR of the DID and R_{N} (283), and encrypts the XOR using an HWK to generate an E_{HWK}(DID xor R_{N}) (284). Then, the HDD sends the E_{HWK}(DID xor R_{N}) to the information processing device.

The information processing device decrypts the received E_{HWK}(DID xor R_{N}) using the HWK (285), and calculates the exclusive-OR of the result of the decryption and R_{N} to generate a DID (286). At this moment, the DID sending process is completed, and afterwards, contents are downloaded and reproduced using the DID.

First, the information processing device sends the obtained DID to the distribution server. The distribution server encrypts the CWK using the received DID to generate an E_{DID}(CWK) (287) and encrypts contents C using the CWK to generate an E_{CWK}(C) (288). Then, the distribution server sends these pieces of information to the information processing device.

The information processing device transfers the received information to the HDD, and the HDD stores the E_{DID}(CWK) and E_{CWK}(C) in the media. Then, the information processing device reads the E_{DID}(CWK) from the HDD, decrypts the E_{DID}(CWK) using the DID and extracts a CWK (289). Then, the information processing device reads the E_{CWK}(C) from the HDD, decrypts the E_{CWK}(C) using the CWK (290) to extract contents C and displays it on the screen 90.

Although an E_{DID}(CWK) and an E_{CWK}(C) can be freely copied, the E_{DID}(CWK) cannot be decrypted without a correct DID. Much less, contents C cannot be reproduced. Although these pieces of information can be copied from an HDD in which they are stored for the first time, to another HDD, they cannot be used. Thus, the illegal use of contents C is prevented. In FIG. 28, although the random storage unit 281 is installed in the information processing device, the unit 281 can also be installed in the HDD.

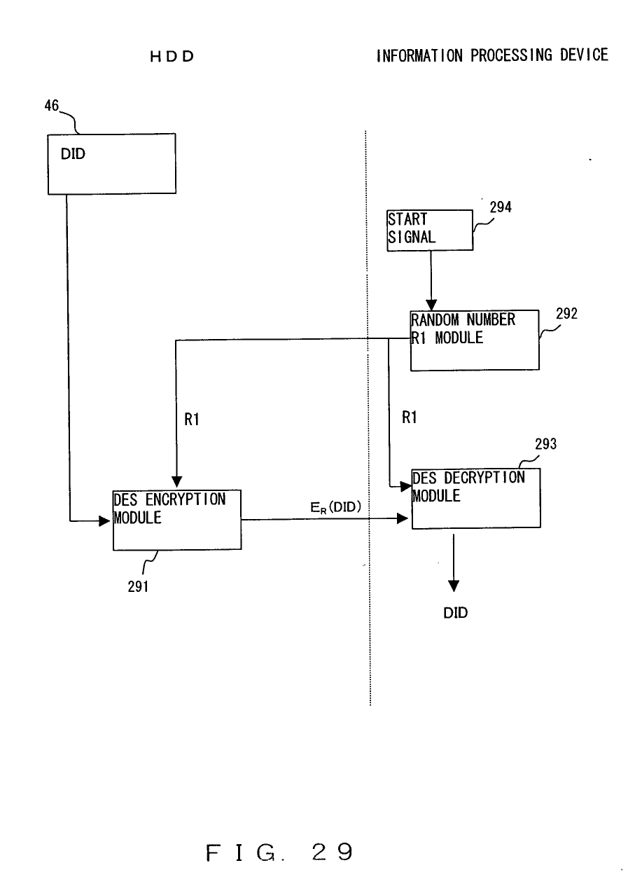

FIG. 29 shows an example of the mechanism realizing the DID sending function by hardware. In this DID sending mechanism, as not in the sequence shown in FIG. 27, a DID is encrypted and sent using a random number R1. The HDD further comprises a DES encryption module 291, and the information processing device further comprises a random number R1 module 292 and a DES decryption module 293.

The random number R1 module 292 is started by a start signal 294 to generate a random number R1 and sends the R1 to the DES encryption module 291. The DES encryption module 291 encrypts a DID 46 using the received R1 to generate an E_{R1}(DID). Then, the DES encryption module 291 sends the E_{R1}(DID) to the DES decryption module 293. The DES decryption module 293 decrypts the E_{R1}(DID) using R1 and outputs a DID.

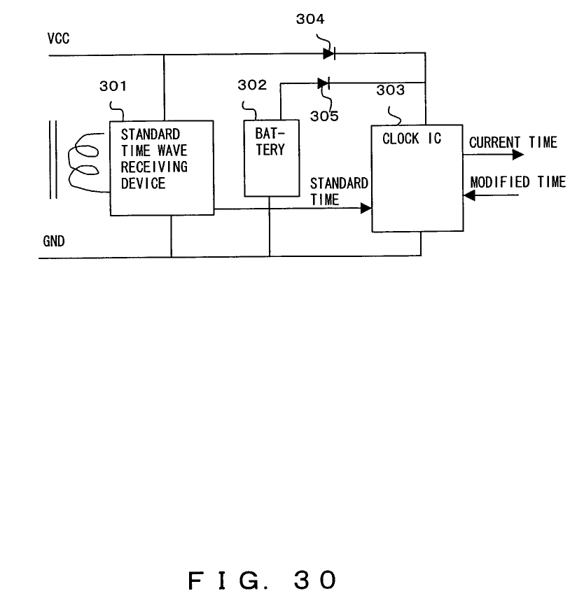

Next, the clock 162 shown in FIG. 13, which is used in the clock function shown in FIG. 11, is described. FIG. 30 shows the configuration of the clock 162. The clock 162 comprises a standard time wave receiving device 301, a battery 302, a clock IC (integrated circuit) 303 and diodes 304 and 305.

The standard time wave receiving device 301 receives a standard time wave and transfers standard time information to the clock IC 303. The clock IC 303 receives the standard time from the standard time wave receiving device 301 and also receives a modified time from the information processing device connected to an HDD. If the standard time is input, the clock IC 303 adjusts the current time to the standard time. If the standard time is not input, the clock IC 303 adjusts the current time to the modified time.

Next, the sector management function using the security tag shown in FIG. 12 is described in more detail. FIG. 31 shows the process of such a sector management function. A user authentication section 311 and a sector address interpretation section 312 are installed as firmware and are stored in the MASKROM 164 shown in FIG. 13.

The non-security sectors 314 of the media 37 correspond to a group of sectors, for each of which access restrictions are not set, and the security sectors correspond to a group of sectors, for each of which access restrictions are set using a security tag. A sector authentication table 313 stores the security tags of the security sector group 315, as shown in FIG. 32, and is stored in the system area 316 of the media 37.

The information processing device 51 issues a general read/write command, a read/write command with an authentication attribute or a user authentication command to the HDD. If the general read/write command is issued, the sector address interpretation unit 312 interprets a received command and reads/writes data from/in the non-security sectors 314. In this case, reading/writing data from/in the security sectors 315 is prohibited.

If a read/write command with an authentication attribute or a user authentication command is issued, the user authentication unit 311 authenticates a user using the user management function shown in FIG. 8 and the reciprocal authentication function shown in FIG. 9 together. When the authentication has completed, the user authentication unit 311 transfers the read/write command to the sector address interpretation unit 312. If there is a request from the information processing device 51, the user authentication unit 311 modifies the access restrictions of the sector authentication table 313.

The sector address interpretation unit 312 interprets the received command and reads/writes data from/into the non-security sectors 314 and security sectors 315. In this case, as for the security sectors 315, reading/writing is conducted under the access restrictions registered in the sector authentication table 313.

Each function of the information processing device connected to a removable HDD is realized by software or hardware. If each function is realized by software, necessary processes are performed by executing programs, such as the application 33 shown in FIG. 4, the secure driver 43 shown in FIG. 6 and the like. Therefore, such an information processing device further comprises a memory storing those programs and data used for the processes and a processor executing the programs. Such an information processing device further comprises an interface communicating with the HDD, a network interface communicating with the distribution server, an input device receiving user's instructions and information and an output device reproducing contents.

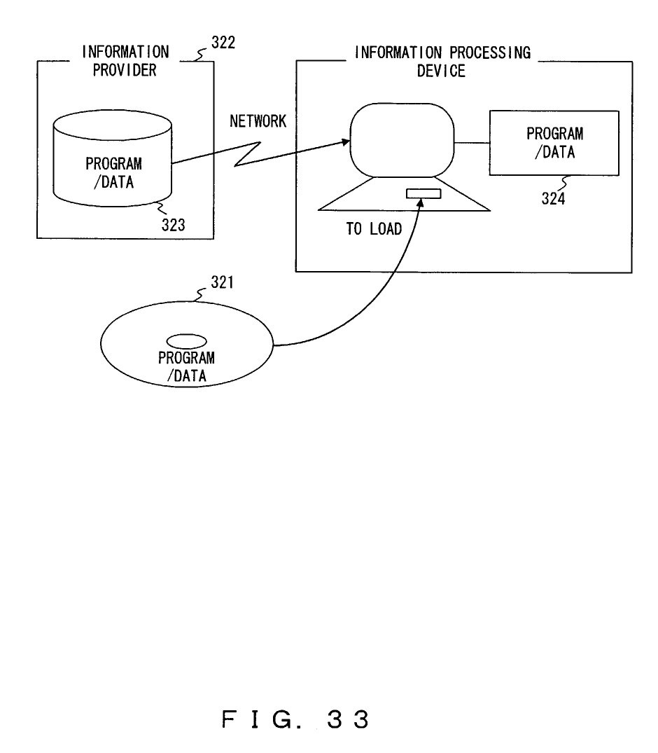

FIG. 33 shows computer-readable storage media providing such an information processing device with the programs and data. The programs and data stored on the portable storage medium 321 or the database 323 of a server 322 are loaded into the memory 324 of the information processing device. In this case, the server 322 generates a propagation signal for propagating the programs and data, and transmits the propagation signal to the information processing device through an arbitrary transmission medium in the communication network. Then, the information processing device performs the necessary processes by executing the programs using the data.

For the portable storage medium, a memory card, a flexible disk, a CD-ROM (compact-disk read-only memory), an optical disk, a magneto-optical disk or the like is used.

The distribution server distributing contents to the information processing device comprises a memory storing data and programs used for the distribution process, including encryption, a processor executing the programs and a network interface communicating with the information processing device.

Although in the preferred embodiments described above, a magnetic disk is used for a removable HDD, another medium, such as an optical disk, a magneto-optical disk or the like, can also be used. The removable HDDs are used in the following situations:

(1) An HDD without contents is sold to a user. Contents are distributed later. In this case, a user can store a plurality of literary works on the HDD.

(2) A rental HDD storing rental digital video

(3) A buffer HDD for a digital broadcast receiver

(4) A buffer HDD for on-demand distribution for a set top box

(5) A recording buffer HDD for digital video

(6) A distribution medium for home video

(7) A backup medium for an application program or OS with a copyright for PC environment

(8) A portable electronic library

(9) A portable video library

(10) A portable music library

(11) A trunk transporting electronic data, which cannot be copied during transportation.

(12) An electronic data safety box, which can be locked.

According to the present invention, even when the removable disk device is separated from an information processing device, contents can be managed. Therefore, the illegal use of contents can be prevented. Thus, the removable disk device can be widely used as a video or music medium.

What is claimed is:

1. A removable disk device to be connected to an information processing device receiving data from a distribution server, comprising:
a disk medium in which unrewritable identification information is recorded;
a reading device reading the identification information from the disk medium in response to a request from the information processing device;
an interface sending the identification information to the information processing device and receiving data that the information processing device has received from the distribution server using the identification information, from the information processing device; and
a writing device writing the data onto the disk medium.

2. A removable disk device to be connected to an information processing device reproducing data, comprising:
a disk medium in which unrewritable identification information is recorded;
a writing device writing data that is encrypted in such a way as to be decrypted using the identification information, onto the disk medium; and
an interface sending the identification information and encrypted data to the information processing device.

3. A removable disk device to be connected to an information processing device, comprising:
a disk medium;
a registration device registering user identification information and an encryption key of each user in such a way to correspond each other;
an authentication device checking whether the information processing device has an encryption key corresponding to user identification information received from the information processing device, by exchanging authentication information with the information processing device using the encryption key, and authenticating the information processing device if the information processing device has the encryption key; and
an access device accessing the disk medium in response to a request from the information processing device after the information processing device has been authenticated.

4. A removable disk device to be connected to an information processing device reproducing data; comprising:
a disk medium;
a writing device writing information representing encrypted data and an expiration time of the data in the disk medium;
a clock outputting a current time;
a comparison device comparing the current time with the expiration time; and
an interface sending information needed to decrypt the encrypted data to the information processing device if the current time is earlier than the expiration time.

5. A removable disk device to be connected to an information processing device, comprising:
a disk medium;
a setting device setting identification information of an owner of each sector of the disk medium and information representing an access restriction on each sector for a user other than the owner; and
an access device accessing a specific sector under the access restriction when a user other than an owner of the specific sector attempts to access the specific sector using the information processing device.

6. An information processing device reproducing data stored in a removable disk device, comprising:
a check device checking whether the removable disk device has unrewritable identification information corresponding to software identification information possessed by the information processing device, by exchanging authentication information generated using the software identification information with the removable disk device; and
an access device accessing data stored in the removable disk device if the removable disk device has the unrewritable identification information.

7. An information processing device reproducing data stored in a removable disk device, comprising:
an authentication device checking whether the removable disk device has an encryption key corresponding to identification information of a user, by exchanging authentication information with the removable disk device using the encryption key, and authenticating the removable disk device if the removable disk device has the encryption key; and
an access device accessing data stored in the removable disk device in response to a request from the user after the removable disk device has been authenticated.

8. A distribution server, comprising:
a receiving device receiving a data request and unrewritable identification information from an information processing device connected to a removable disk device in which the rewritable identification information is recorded;
an encryption device encrypting requested data in such a way as to be decrypted using the identification information; and
a distribution device distributing encrypted data to the information processing device.

9. A computer-readable storage medium on which is recorded a program enabling an information processing device to perform a process for reproducing data stored in a removable disk device, said process comprising:
checking whether the removable disk device has unrewritable identification information corresponding to software identification information of the program, by exchanging authentication information generated using the software identification information with the removable disk device; and
accessing data stored in the removable disk device if the removable disk device has the unrewritable identification information.

10. A computer-readable storage medium on which is recorded a program enabling an information processing device to perform a process for reproducing data stored in a removable disk device, said process comprising:
checking whether the removable disk device has an encryption key corresponding to identification information of a user, by exchanging authentication information with the removable disk device using the encryption key, and authenticating the removable disk device if the removable disk device has the encryption key; and
accessing data stored in the removable disk device in response to a request from the user after the removable disk device has been authenticated.

11. A propagation signal which propagates a program enabling an information processing device to perform a process for reproducing data stored in a removable disk device, said process comprising:
checking whether the removable disk device has unrewritable identification information corresponding to software identification information of the program, by exchanging authentication information generated using the software identification information with the removable disk device; and
accessing data stored in the removable disk device if the removable disk device has the unrewritable identification information.

12. A propagation signal which propagates a program enabling an information processing device to perform a process for reproducing data stored in a removable disk device, said process comprising:
checking whether the removable disk device has an encryption key corresponding to identification information of a user, by exchanging authentication information with the removable disk device using the encryption key, and authenticating the removable disk device if the removable disk device has the encryption key; and
accessing data stored in the removable disk device in response to a request from the user after the removable disk device has been authenticated.

13. A data distribution method, comprising:
receiving a data request and unrewritable identification information from an information processing device connected to a removable disk device in which the unrewritable identification information is recorded;
encrypting requested data in such a way as to be decrypted using the identification information; and
distributing encrypted data to the information processing device.

14. A removable disk device to be connected to an information processing device receiving data from a distribution server, comprising:
disk medium means in which unrewritable identification information is recorded;
reading means for reading the identification information from the disk medium in response to a request from the information processing device;
interface means for sending the identification information to the information processing device and receiving data that the information processing device has received from the distribution server using the identification information, from the information processing device; and
writing means for writing the data onto the disk medium means.

15. A removable disk device to be connected to an information processing device reproducing data, comprising:
disk medium means in which unrewritable identification information is recorded;
writing means for writing data that is encrypted in such away as to be decrypted using the identification information, onto the disk medium means; and
interface means for sending the identification information and encrypted data to the information processing device.

16. A removable disk device connected to an information processing device, comprising:
disk medium means;
registration means for registering user identification information and an encryption key of each user in such a way to correspond each other;
authentication means for checking whether the information processing device has an encryption key corresponding to user identification information received from the information processing device, by exchanging authentication information with the information processing device using the encryption key, and for authenticating the information processing device if the information processing device has the encryption key; and
access means for accessing the disk medium means in response to a request from the information processing device after the information processing device has been authenticated.

17. A removable disk device to be connected to an information processing device reproducing data; comprising:
disk medium means;
writing means for writing information representing encrypted data and an expiration time of the data onto the disk medium means;
clock means for outputting a current time;
comparison means for comparing the current time with the expiration time; and
interface means for sending information needed to decrypt the encrypted data to the information processing device if the current time is earlier than the expiration time.

18. A removable disk device to be connected to an information processing device, comprising:
disk medium means;
setting means for setting identification information of an owner of each sector of the disk device and information representing an access restriction on each sector for a user other than the owner; and
access means for accessing a specific sector under the access restriction when a user other than an owner of the specific sector attempts to access the specific sector using the information processing device.

19. An information processing device reproducing data stored in a removable disk device, comprising:
check means for checking whether the removable disk device has unrewritable identification information corresponding to software identification information possessed by the information processing device, by exchanging authentication information generated using the software identification information with the removable disk device; and
access means for accessing data stored in the removable disk device if the removable disk device has the unrewritable identification information.

20. An information processing device reproducing data stored in a removable disk device, comprising:
authentication means for checking whether the removable disk device has an encryption key corresponding to identification information of a user, by exchanging authentication information with the removable disk device using the encryption key, and for authenticating the removable disk device if the removable disk device has the encryption key; and
access means for accessing data stored in the removable disk device in response to a request from the user after the removable disk device has been authenticated.

21. A distribution server, comprising:
receiving means for receiving a data request and unrewritable identification information from an information processing device connected to a removable disk device in which the unrewritable identification information is recorded;
encryption means for encrypting requested data in such a way as to be decrypted using the identification information; and
distribution means for distributing encrypted data to the information processing device.
